(19) United States
(12) Patent Application Publication
(10) Pub. No.: US 2025/0274751 A1
(43) Pub. Date: Aug. 28, 2025

(54) METHODS, ENTITIES AND COMPUTER READABLE MEDIA FOR NON-3GPP ACCESS AUTHENTICATION

(71) Applicant: Telefonaktiebolaget LM Ericsson (publ), STOCKHOLM (SE)

(72) Inventors: Cheng Wang, SHANGHAI (CN); David CASTELLANOS ZAMORA, MADRID (ES)

(21) Appl. No.: 18/265,454

(22) PCT Filed: Dec. 14, 2021
(86) PCT No.: PCT/CN2021/137970

§ 371 Date: Jun. 6, 2023

(30) Foreign Application Priority Data
Dec. 15, 2020 (WO) PCT/CN2020/136618
Aug. 9, 2021 (WO) PCT/CN2021/111518

(51) Int. Cl. H04W 12/02; H04L 9/40; H04W 8/22; H04W 12/06; H04W 48/16

(52) U.S. Cl. CPC H04W 12/02; H04L 63/0892; H04W 8/22; H04W 12/06; H04W 48/16

(57) ABSTRACT

The present disclosure provides methods, entities, and computer readable media for Non-3GPP access authentication. A method (500A) performed by an entity for AAA incudes: receiving (S501A), from a Non-3GPP access element, a request message for authentication including an identity of a UE to be authenticated, wherein the identity of the UE includes a concealed identity of the UE or a first identity of the UE; detecting (S503A) the identity of the UE from the received request message for authentication; and transmitting (S505A), to an interworking entity, a first request message for authentication credentials, which at least includes the detected identity of the UE.

### TECHNICAL FIELD

The present disclosure generally relates to the technical field of communication technologies, and particularly to methods, entities, and computer readable media for Non-3rd Generation Partnership Project (Non-3GPP) access authentication.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In Evolved Packet System (EPS), besides the native 3rd Generation Partnership Project (3GPP)-access technologies, such as Long Term Evolution (LTE), there is also support for access to data communication services and/or Internet services via Non-3GPP access, including in particular access through a home network, such as a Home Public Land Mobile Network (HPLMN) via Non-3GPP access methods/technologies/networks/standards, e.g. World Interoperability for Microwave Access (WiMAX) according to the standard IEEE 802.16, a Wireless Local Area Network (WLAN), e.g. according to the standard IEEE 802.11g/n, etc.

There are similar deployments in 5G System (5GS).

However, there are some problems in the conventional technical solutions for Non-3GPP access authentication in a scenario of Evolved Packet Core (EPC) and 5G Core (5GC) coexistence.

### SUMMARY

In order to at least partly solve the above problems in the conventional technical solutions, the present disclosure provides several mechanisms to support the retrieval of authentication credentials based on the privacy protected subscriber identity, e.g., SUCI, in the Non-3GPP access authentication procedure, which may at least include:
a standalone concealed identity de-concealment service, to enable the entity for AAA (e.g., the AAA server) to get a clear text subscriber identity, i.e., a de-concealed identity, from the entity for authentication in 5GC (e.g., the UDM) and proceed authentication e.g. for NSWO following the baseline procedure as defined in EPC;
an enhancement of Diameter-based and UDICOM-based services, to enable the entity for AAA or the entity for authentication in EPC (e.g., the HSS) to handle the concealed identity in the Diameter-based interface and the UDICOM interface and proceed authentication e.g. for NSWO following the baseline procedure as defined in EPC;
an enhancement of UDICOM-based services, to enable the entity for authentication in 5GC to fetch authentication credentials from the entity for authentication in EPC and then pass to the entity for AAA to enable the entity for AAA to proceed authentication e.g. for NSWO following the baseline procedure as defined in EPC; and
a scheme in which the UE to be authenticated may determine whether to activate UE identity privacy, e.g., based on at least one of: information from a Non-3GPP access element, e.g., a Non-3GPP Access Point (AP), information provisioned from the home network of the UE, or configuration of the UE.

According to a first aspect of the present disclosure, a method performed by a Non-3GPP access element in a Non-3GPP access network is provided. The method includes: transmitting a list of networks, via each of which the Non-3GPP access element at least has support for UE identity privacy.

In an exemplary embodiment, the Non-3GPP access element, via each network in the list of networks, further has support for connectivity with an entity for AAA for access authentication.

In an exemplary embodiment, the method further includes: receiving, from a UE, a request message for access authentication including an identity of the UE; and transmitting, to the entity for AAA, a request message for authentication including the identity of the UE.

In an exemplary embodiment, the identity of the UE includes a concealed identity of the UE or a first identity of the UE.

In an exemplary embodiment, the concealed identity of the UE includes a SUCI of the UE, and the first identity of the UE includes an International Mobile Subscriber Identification (IMSI) of the UE.

In an exemplary embodiment, the request message for authentication further includes an access network identity of the Non-3GPP access network.

In an exemplary embodiment, the list of networks includes a list of Public Land Mobile Networks (PLMNs), and the entity for AAA includes a 3GPP AAA server.

According to a second aspect of the present disclosure, a Non-3GPP access element in a Non-3GPP access network is provided. The Non-3GPP access element includes: at least one processor, and at least one memory, storing instructions which, when executed on the at least one processor, cause the Non-3GPP access element to perform any of the methods according to the first aspect of the present disclosure.

According to a third aspect of the present disclosure, a method performed by a UE is provided. The method includes: determining whether UE identity privacy should be used for communication with a Non-3GPP access network for the UE; and transmitting, to a Non-3GPP access element in the Non-3GPP access network, a request message for access authentication that includes an identity of the UE depending on a result of the determination.

In an exemplary embodiment, it is determined whether the UE identity privacy should be used for communication with the Non-3GPP access network for the UE based on at least one of:
configuration of the UE;
information about the Non-3GPP access element in the Non-3GPP access network; or
information about a home network of the UE.

In an exemplary embodiment, the method further includes: receiving or preconfiguring the configuration of the UE, which includes: information indicating whether the UE has support for the UE identity privacy.

In an exemplary embodiment, the method further includes: receiving, from the Non-3GPP access element, the information about the Non-3GPP access element indicating whether the Non-3GPP access element has support for the UE identity privacy, wherein the information about the Non-3GPP access element includes a list of networks, via each of which the Non-3GPP access element at least has the support for the UE identity privacy.

In an exemplary embodiment, the Non-3GPP access element, via each network in the list of networks, further has support for connectivity with an entity for AAA for access authentication.

In an exemplary embodiment, the method further includes: receiving, from the home network, the information about the home network indicating whether the home network has support for the UE identity privacy.

In an exemplary embodiment, the information about the home network indicating whether the home network has support for the UE identity privacy is carried in a UE Parameter Update (UPU) procedure or a Steering of Roaming (SoR) procedure.

In an exemplary embodiment, the support for the UE identity privacy includes support for the UE identity privacy for Non-3GPP access authentication.

In an exemplary embodiment, the request message for access authentication includes a concealed identity of the UE, if it is determined that the UE identity privacy should be used, and the request message for access authentication includes a first identity of the UE should be used, if it is determined that the UE identity privacy should not be used.

In an exemplary embodiment, the concealed identity of the UE includes a SUCI of the UE, and the first identity of the UE includes an IMSI of the UE.

In an exemplary embodiment, the communication with the Non-3GPP access network includes NSWO from the Non-3GPP access network for the UE.

In an exemplary embodiment, the list of networks includes a list of PLMNs, and the entity for AAA includes a 3GPP AAA server.

According to a fourth aspect of the present disclosure, a UE is provided. The UE includes: at least one processor, and at least one memory, storing instructions which, when executed on the at least one processor, cause the UE to perform any of the methods according to the third aspect of the present disclosure.

According to a fifth aspect of the present disclosure, a method performed by an entity for AAA is provided. The method includes: receiving, from a Non-3GPP access element, a request message for authentication including an identity of a UE to be authenticated, wherein the identity of the UE includes a concealed identity of the UE or a first identity of the UE; detecting the identity of the UE from the received request message for authentication; and transmitting, to an interworking entity, a first request message for authentication credentials, which at least includes the detected identity of the UE.

In an exemplary embodiment, the first request message for authentication credentials is transmitted to the interworking entity via a routing entity.

In an exemplary embodiment, in a case where the identity of the UE in the received request message for authentication includes the concealed identity of the UE, the concealed identity of the UE is detected; and the first request message for authentication credentials includes the detected concealed identity of the UE, and is transmitted to the interworking entity over a Diameter-based interface supporting the concealed identity of the UE.

In an exemplary embodiment, in a case where the identity of the UE in the received request message for authentication includes the first identity of the UE or the concealed identity of the UE that is protected with a Null Scheme, the first identity of the UE is detected; and the first request message for authentication credentials includes the first identity of the UE, and is transmitted to the interworking entity over a Diameter-based interface supporting the first identity of the UE.

In an exemplary embodiment, the method further includes: receiving, from the interworking entity, a first response message for authentication credentials, which includes: an authentication method selected by an entity for authentication in 5GC associated with the UE or requested by the entity for authentication in 5GC from an entity for authentication in EPC associated with the UE, an authentication vector generated by the entity for authentication in 5GC or requested by the entity for authentication in 5GC from the entity for authentication in EPC, and a first identity of the UE obtained from the detected identity of the UE.

In an exemplary embodiment, the concealed identity of the UE includes a SUCI of the UE, and the first identity of the UE includes an IMSI of the UE.

In an exemplary embodiment, the request message for authentication further includes an access network identity related to the Non-3GPP access element, and the first request message for authentication credentials further includes the access network identity related to the Non-3GPP access element.

According to a sixth aspect of the present disclosure, a method performed by an entity for AAA is provided. The method includes: receiving, from a Non-3GPP access element, a request message for authentication including a concealed identity of a UE to be authenticated; detecting the concealed identity of the UE from the received request message for authentication; and transmitting, to an interworking entity, an identity request message including the detected concealed identity of the UE.

In an exemplary embodiment, the identity request message is transmitted to the interworking entity via a routing entity.

In an exemplary embodiment, the concealed identity of the UE includes a SUCI of the UE.

In an exemplary embodiment, the method further includes: receiving, from the interworking entity, an identity response message including a first identity of the UE, which is converted by the interworking entity from a second identity of the UE that is in turn de-concealed by an entity for authentication in 5GC associated with the UE from the concealed identity of the UE; and forwarding the identity response message to the entity for AAA.

In an exemplary embodiment, the identity request message is transmitted over a Diameter-based interface supporting the concealed identity of the UE, and the identity response message is received over the Diameter-based interface.

In an exemplary embodiment, the method further includes: transmitting, to an entity for authentication in EPC associated with the UE, a second request message for authentication credentials, which at least includes the received first identity of the UE; and receiving, from the entity for authentication in EPC, a second response message for authentication credentials, which includes: an authentication method selected by the entity for authentication in EPC, or requested by the entity for authentication in EPC from the entity for authentication in 5GC, and an authentication vector generated by the entity for authentication in EPC or requested by the entity for authentication in EPC from the entity for authentication in 5GC.

In an exemplary embodiment, the first identity of the UE includes an IMSI of the UE, and the second identity of the UE includes a Subscription Permanent Identifier (SUPI) of the UE.

In an exemplary embodiment, the entity for AAA includes a 3GPP AAA server, and the routing entity includes a Subscription Locator Function (SLF)/Diameter Routing Agent (DRA).

According to a seventh aspect of the present disclosure, an entity for AAA is provided. The entity for AAA includes: at least one processor, and at least one memory, storing instructions which, when executed on the at least one processor, cause the entity for AAA to perform any of the methods according to the fifth to sixth aspects of the present disclosure.

According to an eighth aspect of the present disclosure, a method performed by a routing entity is provided. The method includes: receiving, from an entity for AAA, a first request message for authentication credentials, which at least includes an identity of a UE to be authenticated, wherein the identity of the UE includes a concealed identity of the UE or a first identity of the UE; and forwarding the first request message for authentication credentials to an interworking entity.

In an exemplary embodiment, in a case where the identity of the UE includes the concealed identity of the UE, the first request message for authentication credentials is received and forwarded over a Diameter-based interface supporting the concealed identity of the UE.

In an exemplary embodiment, in a case where the identity of the UE includes the first identity of the UE, the first request message for authentication credentials is received and forwarded over a Diameter-based interface supporting the first identity of the UE.

In an exemplary embodiment, the method further includes: receiving, from the interworking entity, a first response message for authentication credentials, which includes: an authentication method selected by an entity for authentication in 5GC associated with the UE or requested by the entity for authentication in 5GC from an entity for authentication in EPC associated with the UE, an authentication vector generated by the entity for authentication in 5GC or requested by the entity for authentication in 5GC from the entity for authentication in EPC, and a first identity of the UE obtained from the identity of the UE; and forwarding the first response message for authentication credentials to the entity for AAA.

In an exemplary embodiment, the concealed identity of the UE includes a SUCI of the UE, and the first identity of the UE includes an IMSI of the UE.

In an exemplary embodiment, the first request message for authentication credentials further includes an access network identity related to a Non-3GPP access element to which the UE is connected.

According to a ninth aspect of the present disclosure, a method performed by a routing entity is provided. The method includes: receiving, from an entity for AAA, an identity request message including a concealed identity of a UE to be authenticated; and forwarding the identity request message to an interworking entity.

In an exemplary embodiment, the concealed identity of the UE includes a SUCI of the UE.

In an exemplary embodiment, the method further includes: receiving, from the interworking entity, an identity response message including a first identity of the UE, which is converted by the interworking entity from a second identity of the UE that is in turn de-concealed by an entity for authentication in 5GC associated with the UE from the concealed identity of the UE.

In an exemplary embodiment, the identity request message is received and forwarded over a Diameter-based interface supporting the concealed identity of the UE, and the identity response message of the UE is received and forwarded over the Diameter-based interface.

In an exemplary embodiment, the method further includes: receiving, from the entity for AAA, a second request message for authentication credentials for the UE, which at least includes the received first identity of the UE; and forwarding, to an entity for authentication in EPC associated with the UE, the received second request message for authentication credentials.

In an exemplary embodiment, the first identity of the UE includes an IMSI of the UE, and the second identity of the UE includes a SUPI of the UE.

In an exemplary embodiment, the method further includes: receiving, from the entity for authentication in EPC, a second response message for authentication credentials, which includes: an authentication method selected by the entity for authentication in EPC or requested by the entity for authentication in EPC from the entity for authentication in 5GC, and an authentication vector generated by the entity for authentication in EPC or requested by the entity for authentication in EPC from an entity for authentication in 5GC; and forwarding, to the entity for AAA, the received second response message for authentication credentials.

In an exemplary embodiment, the routing entity includes an SLF/DRA, and the entity for AAA includes a 3GPP AAA server.

According to a tenth aspect of the present disclosure, a routing entity is provided. The routing entity includes: at least one processor, and at least one memory, storing instructions which, when executed on the at least one processor, cause the routing entity to perform any of the methods according to the eighth to ninth aspects of the present disclosure.

According to an eleventh aspect of the present disclosure, a method performed by an interworking entity is provided. The method includes: receiving, from an entity for AAA, a first request message for authentication credentials, which at least includes an identity of a UE to be authenticated, wherein the received identity of the UE includes a concealed identity of the UE or a first identity of the UE; selecting an entity for authentication in 5GC associated with the UE based on the received identity of the UE; and transmitting, to the selected entity for authentication in 5GC, a fourth request message for authentication credentials.

In an exemplary embodiment, the first request message for authentication credentials is received from the entity for AAA via a routing entity.

In an exemplary embodiment, the method further includes: receiving, from the selected entity for authentication in 5GC, a fourth response message for authentication credentials, wherein the fourth response message for authentication credentials at least includes: an authentication method selected by the selected entity for authentication in 5GC or requested by the selected entity for authentication in 5GC from an entity for authentication in EPC associated with the UE, and an authentication vector generated by the selected entity for authentication in 5GC or requested by the selected entity for authentication in 5GC from the entity for authentication in EPC.

In an exemplary embodiment, in a case where the received identity of the UE includes the concealed identity of the UE, the first request message for authentication credentials is received over a Diameter-based interface supporting the concealed identity of the UE, the entity for authentication in 5GC is selected based on a routing indicator included in the received concealed identity of the UE, the fourth request message for authentication credentials at least includes an indication of a requesting node being the entity for AAA and the concealed identity of the UE, and the fourth response message for authentication credentials further includes a second identity of the UE that is de-concealed by the entity for authentication in 5GC from the concealed identity of the UE.

In an exemplary embodiment, in a case where the received identity of the UE includes the first identity of the UE, the first request message for authentication credentials is received over a Diameter-based interface supporting the first identity of the UE, the entity for authentication in 5GC is selected based on the first identity of the UE, the fourth request message for authentication credentials at least includes an indication of a requesting node being the entity for AAA and a second identity of the UE that is converted by the interworking entity from the first identity of the UE, and the fourth response message for authentication credentials further includes the second identity of the UE.

In an exemplary embodiment, the fourth request message for authentication credentials further includes an access network identity related to a Non-3GPP access element to which the UE is connected.

In an exemplary embodiment, the method further includes: transmitting, to the entity for AAA, a first response message for authentication credentials, which includes: the authentication method, the authentication vector, and a first identity of the UE obtained from the received identity of the UE.

In an exemplary embodiment, the concealed identity of the UE includes a SUCI of the UE, and the first identity of the UE includes an IMSI of the UE.

According to a twelfth aspect of the present disclosure, a method performed by an interworking entity is provided. The method includes: receiving, from an entity for AAA, an identity request message including a concealed identity of a UE to be authenticated; selecting an entity for authentication in 5GC associated with the UE based on the received concealed identity of the UE; and transmitting, to the selected entity for authentication in 5GC, a request message for identity de-concealment, which includes the received concealed identity of the UE.

In an exemplary embodiment, the identity request message is received from the entity for AAA via a routing entity.

In an exemplary embodiment, the identity request message is received over a Diameter-based interface supporting the concealed identity of the UE, and the entity for authentication in 5GC associated with the UE is selected based on a routing indicator included in the received concealed identity of the UE.

In an exemplary embodiment, the concealed identity of the UE includes a SUCI of the UE.

In an exemplary embodiment, the method further includes: receiving, from the selected entity for authentication in 5GC, a response message for identity de-concealment, which includes a second identity of the UE that is de-concealed by the selected entity for authentication in 5GC from the concealed identity of the UE; converting the received second identity of the UE to a first identity of the UE; and transmitting, to the entity for AAA, an identity response message including the first identity of the UE.

In an exemplary embodiment, the first identity of the UE includes an IMSI of the UE, and the second identity of the UE includes a SUPI of the UE.

In an exemplary embodiment, the routing entity includes an SLF/DRA, and the entity for AAA includes a 3GPP AAA server.

According to a thirteenth aspect of the present disclosure, an interworking entity is provided. The interworking entity includes: at least one processor, and at least one memory, storing instructions which, when executed on the at least one processor, cause the interworking entity to perform any of the methods according to the eleventh to twelfth aspects of the present disclosure.

According to a fourteenth aspect of the present disclosure, a method performed by an entity for authentication in 5GC is provided. The method includes: receiving, from an interworking entity, a fourth request message for authentication credentials for a UE to be authenticated, which at least includes an indication of a requesting node being an entity for AAA, and an identity of the UE; and transmitting a fourth response message for authentication credentials to the interworking entity.

In an exemplary embodiment, the fourth request message for authentication credentials further includes an access network identity related to a Non-3GPP access element to which the UE is connected.

In an exemplary embodiment, the received identity of the UE includes a concealed identity of the UE, and the method further includes: de-concealing a second identity of the UE from the received concealed identity of the UE.

In an exemplary embodiment, the received identity of the UE includes a second identity of the UE.

In an exemplary embodiment, the method further includes: selecting an authentication method for the UE at least based on the indication of the requesting node being the entity for AAA and the second identity of the UE; and generating an authentication vector for the UE at least based on the second identity of the UE.

In an exemplary embodiment, the method further includes: transmitting, to the entity for authentication in EPC, a fifth request message for authentication credentials, which at least includes: the indication of the requesting node being the entity for AAA, and the identity of the UE; and receiving, from the entity for authentication in EPC, a fifth response message for authentication credentials, which includes an authentication method for the UE and an authentication vector for the UE.

In an exemplary embodiment, the concealed identity of the UE includes a SUCI of the UE, and the second identity of the UE includes a SUPI of the UE.

In an exemplary embodiment, the fifth request message for authentication credentials further includes an access network identity related to a Non-3GPP access element to which the UE is connected.

According to a fifteenth aspect of the present disclosure, a method performed by an entity for authentication in 5GC is provided. The method includes:

receiving, from an interworking entity, a request message for identity de-concealment, which includes a concealed identity of a UE to be authenticated; de-concealing a second identity of the UE from the received concealed identity of the UE; and transmitting, to the interworking entity, a response message for identity de-concealment, which includes the second identity of the UE.

In an exemplary embodiment, the concealed identity of the UE includes a SUCI of the UE, and the second identity of the UE includes a SUPI of the UE.

In an exemplary embodiment, the entity for AAA includes a 3GPP AAA server.

According to a sixteenth aspect of the present disclosure, an entity for authentication in 5GC is provided. The entity for authentication in 5GC includes: at least one processor, and at least one memory, storing instructions which, when executed on the at least one processor, cause the entity for authentication in 5GC to perform any of the methods according to the fourteenth to fifteenth aspects of the present disclosure.

According to a seventeenth aspect of the present disclosure, a method performed by an entity for authentication in EPC is provided. The method includes: receiving, from an entity for authentication in 5GC associated with a UE to be authenticated, a fifth request message for authentication credentials, which at least includes: an indication of a requesting node being an entity for AAA, and a first identity of the UE; obtaining authentication credentials for the UE; and transmitting, to the entity for authentication in 5GC, a fifth response message for authentication credentials, which includes the obtained authentication credentials for the UE.

In an exemplary embodiment, the authentication credentials for the UE includes: an authentication method for the UE and an authentication vector for the UE, and said obtaining the authentication credentials for the UE includes:
selecting an authentication method for the UE at least based on the indication of the requesting node being the entity for AAA and the first identity of the UE;
and generating an authentication vector for the UE at least based on the first identity of the UE.

In an exemplary embodiment, the first identity of the UE includes an IMSI of the UE.

In an exemplary embodiment, the fifth request message for authentication credentials further includes an access network identity related to a Non-3GPP access element to which the UE is connected.

In an exemplary embodiment, the method further includes: registering, in an entity for network repository, a routing indicator that the entity for authentication in EPC supports.

In an exemplary embodiment, the entity for AAA includes a 3GPP AAA server.

According to an eighteenth aspect of the present disclosure, an entity for authentication in EPC is provided. The entity for authentication in EPC includes: at least one processor, and at least one memory, storing instructions which, when executed on the at least one processor, cause the entity for authentication in EPC to perform any of the methods according to seventeenth aspect of the present disclosure.

According to a nineteenth aspect of the present disclosure, a computer readable storage medium is provided. The computer readable storage medium has computer program instructions stored thereon, the computer program instructions, when executed by at least one processor, causing the at least one processor to perform the method according to any of the first, third, fifth to sixth, eighth to ninth, eleventh to twelfth, fourteenth to fifteenth, and seventeenth aspects of the present disclosure.

The technical solutions of the present disclosure may enable Non-3GPP access authentication with minimum/no impact on the existing access network, e.g., Wi-Fi and the 5GC, providing the support for retrieval of authentication credentials based on the concealed identity, e.g., SUCI, of the UE to be authenticated in the Non-3GPP access authentication procedure. In particular, the technical solutions of the present disclosure may at least support for:
handling the concealed identity in the entity for AAA (e.g., AAA server);

handling the concealed identity over UDICOM for EPC coexistence case;

handling retrieval of authentication credentials from the entity for authentication in 5GC (e.g., UDM) to the entity for authentication in EPC (e.g., HSS); and determining the use of the concealed identity in the UE to be authenticated, etc.

### BRIEF DESCRIPTION OF THE DRAWINGS

The objects, advantages and characteristics of the present disclosure will be more apparent, according to descriptions of preferred embodiments in connection with the drawings, in which:

FIG. 1 schematically shows an exemplary non-roaming architecture within EPS supporting for 3GPP access and Non-3GPP access;

FIG. 2 schematically shows an exemplary Non-3GPP access authentication architecture in 5GC with EPS coexistence, in which exemplary embodiments of the present disclosure are applied;

FIG. 3 schematically shows an exemplary method performed by a Non-3GPP access element in a Non-3GPP access network according to an exemplary embodiment of the present disclosure;

FIG. 4 schematically shows an exemplary method performed by a UE according to an exemplary embodiment of the present disclosure;

FIG. 5A schematically shows an exemplary method performed by an entity for AAA according to a first exemplary embodiment of the present disclosure;

FIG. 5B schematically shows an exemplary method performed by an entity for AAA according to a second exemplary embodiment of the present disclosure;

FIG. 5C schematically shows an exemplary method performed by an entity for AAA according to a third exemplary embodiment of the present disclosure;

FIG. 6A schematically shows an exemplary method performed by a routing entity according to a first exemplary embodiment of the present disclosure;

FIG. 6B schematically shows an exemplary method performed by a routing entity according to a second exemplary embodiment of the present disclosure;

FIG. 6C schematically shows an exemplary method performed by a routing entity according to a third exemplary embodiment of the present disclosure;

FIG. 7A schematically shows an exemplary method performed by an interworking entity according to a first exemplary embodiment of the present disclosure;

FIG. 7B schematically shows an exemplary method performed by an interworking entity according to a second exemplary embodiment of the present disclosure;

FIG. 8A schematically shows an exemplary method performed by an entity for authentication in 5GC according to a first exemplary embodiment of the present disclosure;

FIG. 8B schematically shows an exemplary method performed by an entity for authentication in 5GC according to a second exemplary embodiment of the present disclosure;

FIG. 8C schematically shows an exemplary method performed by an entity for authentication in 5GC according to a third exemplary embodiment of the present disclosure;

FIG. 9A schematically shows an exemplary method performed by an entity for authentication in EPC according to a first exemplary embodiment of the present disclosure;

FIG. 9B schematically shows an exemplary method performed by an entity for authentication in EPC according to a third exemplary embodiment of the present disclosure;

FIG. 10A schematically shows an exemplary signaling sequence diagram for Non-3GPP access authentication according to the first exemplary embodiment of the present disclosure, in which the methods of FIGS. 3, 4, 5A, 6A, 7A, 8A and 9A are applied;

FIG. 10B schematically shows an exemplary signaling sequence diagram for Non-3GPP access authentication according to the second exemplary embodiment of the present disclosure, in which the methods of FIGS. 3, 4, 5B, 6B, 7B, and 8B are applied;

FIG. 10C schematically shows an exemplary signaling sequence diagram for Non-3GPP access authentication according to the third exemplary embodiment of the present disclosure, in which the methods of FIGS. 3, 4, 5C, 6C, 8C, and 9B are applied;

FIG. 11 schematically shows an exemplary structural block diagram of a Non-3GPP access element according to any of the first to third exemplary embodiments of the present disclosure;

FIG. 12 schematically shows another exemplary structural block diagram of a Non-3GPP access element according to any of the first to third exemplary embodiments of the present disclosure;

FIG. 13 schematically shows an exemplary structural block diagram of a UE according to any of the first to third exemplary embodiments of the present disclosure;

FIG. 14 schematically shows another exemplary structural block diagram of a UE according to any of the first to third exemplary embodiments of the present disclosure;

FIG. 15 schematically shows an exemplary structural block diagram of an entity for AAA according to any of the first to third exemplary embodiments of the present disclosure;

FIG. 16 schematically shows another exemplary structural block diagram of an entity for AAA according to any of the first to third exemplary embodiments of the present disclosure;

FIG. 17A schematically shows an exemplary structural block diagram of a routing entity according to any of the first to second exemplary embodiments of the present disclosure;

FIG. 17B schematically shows an exemplary structural block diagram of a routing entity according to the third exemplary embodiments of the present disclosure;

FIG. 18 schematically shows another exemplary structural block diagram of a routing entity according to any of the first to third exemplary embodiments of the present disclosure;

FIG. 19 schematically shows an exemplary structural block diagram of an interworking entity according to any of the first and second exemplary embodiments of the present disclosure;

FIG. 20 schematically shows another exemplary structural block diagram of an interworking entity according to any of the first and second exemplary embodiments of the present disclosure;

FIG. 21A schematically shows an exemplary structural block diagram of an entity for authentication in 5GC according to the first exemplary embodiment of the present disclosure;

FIG. 21B schematically shows an exemplary structural block diagram of an entity for authentication in 5GC according to any of the second and third exemplary embodiments of the present disclosure;

FIG. 22 schematically shows another exemplary structural block diagram of an entity for authentication in 5GC according to any of the first to third exemplary embodiments of the present disclosure;

FIG. 23A schematically shows an exemplary structural block diagram of an entity for authentication in EPC according to the first exemplary embodiment of the present disclosure;

FIG. 23B schematically shows an exemplary structural block diagram of an entity for authentication in EPC according to the third exemplary embodiment of the present disclosure; and

FIG. 24 schematically shows another exemplary structural block diagram of an entity for authentication in EPC according to any of the first and third exemplary embodiments of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of exemplary embodiments.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “and/or” includes any and all combinations of one or more of the associated listed terms.

In the following description and claims, unless defined otherwise, all technical and scientific terms used herein have the same meaning as commonly understood by one of ordinary skills in the art to which this disclosure belongs. As used herein, the term “network” refers to a network following any suitable (wireless or wired) communication standards. For example, the wireless communication standards may include new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably.

Furthermore, the communications between two devices in the network may be performed according to any suitable communication protocols, including, but not limited to, the wireless communication protocols as defined by a standard organization such as 3GPP or the wired communication protocols. For example, the wireless communication protocols may include the first generation (1G), 2G, 3G, 4G, 4.5G, 5G communication protocols, and/or any other protocols either currently known or to be developed in the future.

The term “entity” or “network entity” used herein refers to a network device or network node or network function in a communication network, and may also refer to a virtualized entity that may be implemented on cloud. For example, in a wireless communication network such as a 3GPP-type cellular network, a core network device may offer numerous services to customers who are interconnected by an access network device. Each access network device is connectable to the core network device over a wired or wireless connection.

The term “CN entity” refers to any suitable function which can be implemented in a network entity (physical or virtual) of a communication network. For example, a network entity can be implemented either as a network element on a dedicated hardware, as a software instance running on a dedicated hardware, or as a virtualized function instantiated on an appropriate platform, e.g. on a cloud infrastructure. For example, the 5G Core Network system (5GC) may include a plurality of functions such as AMF, SMF, UDM (Unified Data Management), PCF (Policy Control Function), UPF (User plane Function), NRF (Network Repository Function), etc. For example, the 4G Core Network system (such as EPC) may include MME, HSS (home subscriber server), P-GW, BM-SC, etc. In other embodiments, the CN entity may include different types of functions for example depending on the specific network.

As previously described, in EPS, besides the native 3GPP-access technologies, such as LTE, there is also support for access to data communication services and/or Internet services via Non-3GPP access, including in particular access through a home network, such as a HPLMN via Non-3GPP access methods/technologies/networks/standards, e.g. WiMAX according to the standard IEEE 802.16, a WLAN, e.g. according to the standard IEEE 802.11g/n, etc.

It may be understood that the Non-3GPP access means access using an access technology whose specification is outside the scope of 3GPP. There are two categories of Non-3GPP access: trusted Non-3GPP access and non-trusted Non-3GPP access (also called “untrusted” Non-3GPP access).

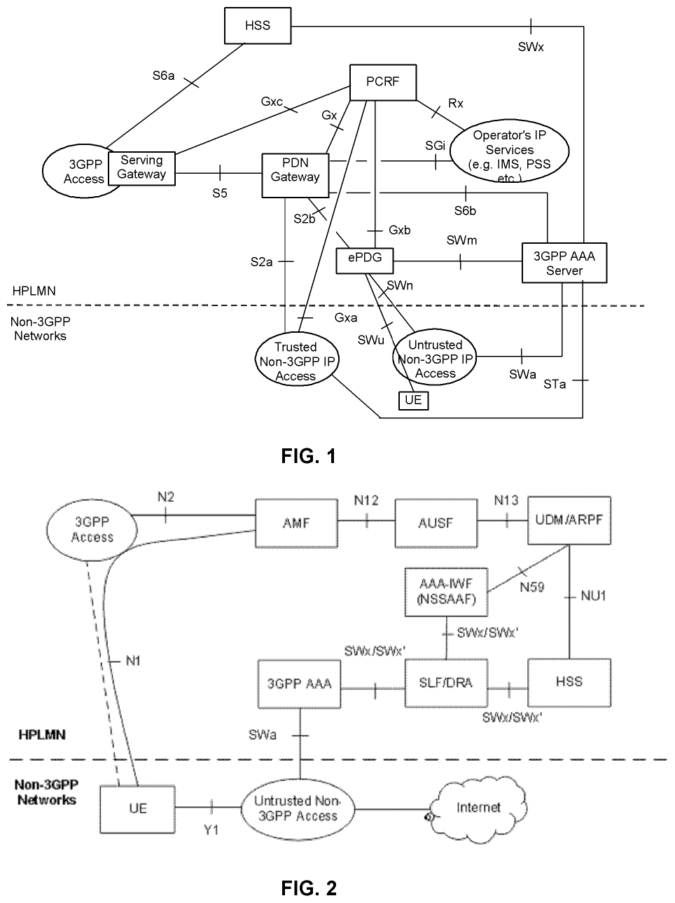

FIG. 1 schematically shows an exemplary non-roaming architecture within EPS supporting for not only the 3GPP access but also the Non-3GPP access as defined in 3GPP TS 23.402 v16.0.0, “Architecture enhancement for Non-3GPP accesses”, which is incorporated herein in its entirety by reference.

For the 3GPP access, the 3GPP access point (the “3GPP Access” in FIG. 1) authenticates with the Home Subscriber Server (HSS), as an example of an entity for authentication in EPC, for the User Equipment (UE) via the S6a reference point (also called “interface” herein). After the authentication is successful, the 3GPP access point establishes an IP connection for the UE over the Evolved Packet Core (EPC), i.e., connected via the S5 and SGi reference points to the Operator's IP Services.

For the trusted Non-3GPP access, the trusted Non-3GPP access point (the “Trusted Non-3GPP IP Access” in FIG. 1) authenticates with the HSS for the UE by means of a 3GPP Authentication, Authorization and Accounting (AAA) server, as an example of an entity for AAA, i.e., via the STa and the SWx reference points. After the authentication is successful, the trusted Non-3GPP access point establishes an IP connection over the EPC, i.e., connected via the S2a and SGi reference points to the Operator's IP Services.

For the untrusted Non-3GPP access, the untrusted Non-3GPP access point (the “Untrusted Non-3GPP IP Access” in FIG. 1) is connected to the Evolved Packet Core (EPC) via the 3GPP AAA server over an evolved Packet Data Gateway (ePDG). For the untrusted access, the UE and the ePDG shall perform mutual authentication during the Internet Protocol Security (IPsec) tunnel establishment between the UE and the ePDG over the SWu reference point. The UE is connected to the ePDG via the SWu reference point, and the ePDG authenticates with the HSS for the UE by means of the 3GPP AAA server, i.e., via the SWm and SWx reference points. After the authentication is successful, the ePDG establishes an IP connection over the EPC, i.e., via the S2b and SGi reference points to the Operator's IP Services.

What the above three types of access have in common is that the authentication related information (e.g. Authentication and Key Agreement (AKA) Authentication Vectors (AVs) for Extensible Authentication Protocol (EAP)-AKA or EAP-AKA′) is fetched from the HSS in EPC for authentication of the UE; after the authentication is successful, an IP connection is established for the UE over the EPC, and the Operator's IP Services may be connected via the SGi reference point, no matter the previous reference point is S5 (for the 3GPP access), S2a (for the trusted Non-3GPP access) or S2b (for the untrusted Non-3GPP access).

In addition, the Non-3GPP access network may also provide an “offload” function, i.e., directly connected to e.g., the Internet via the Non-3GPP access network without establishing a data connection over the EPC, e.g., Non-Seamless WLAN Offload (NSWO).

In the example of FIG. 1, for the purpose of offload from e.g. the untrusted Non-3GPP access network, before the IPsec tunnel establishment between the UE and the ePDG can be performed, the UE needs to obtain IP connectivity across the access network, which may require additional access authentication. The additional access authentication is independent of the EAP-AKA authentication running in conjunction with the IPsec tunnel establishment over the ePDG, and may be required for the security of the untrusted Non-3GPP access network and achieved over the SWa reference point.

The SWa reference point transports access authentication, authorization and charging-related information in a secure manner. The 3GPP AAA server fetches authentication related information (e.g. AKA AVs for EAP-AKA or EAP-AKA′), subscription and Packet Data Network (PDN) connection data from the HSS in EPC via the SWx reference point.

After the authentication of the UE via the SWa and SWx reference points is successful, the UE will not establish data connection over the EPC, but connects to e.g. the Internet via the untrusted Non-3GPP access network, i.e., offload to the untrusted Non-3GPP access network.

A typical use of this additional access authentication is for Wi-Fi access authentication e.g. in stadia, hotels, coffee shops etc. This is, only SWa with the 3GPP AAA server is used, but mobility and PDN connectivity services are not required from the EPC (i.e. ePDG/SWm is not required). This deployment allows a UE to connect to a Non-3GPP access network (e.g., WLAN) using Subscriber Identity Module (SIM)-based access authentication via the mobile network core and to offload selected traffic to the Non-3GPP access network.

This is a deployed feature in 4G networks, which allows the use of mobile network subscription and roaming agreements for Non-3GPP access and for offloading selected traffic to the Non-3GPP access network where the selection of the traffic to offload is based on policies and where the offloaded traffic is not using 3GPP defined entities.

3GPP has approved a study item “New SID on Non Seamless WLAN Offload in 5GC using 3GPP credentials” (3GPP TSG-SA Meeting #91-e e-meeting, 18˜29 Mar. 2021, SP-210262, which is incorporated herein in its entirety by reference) to enable a deployment feature in 5G System (5GS), which is similar with that in EPC. The objectives defined in the Study Item Description (SID) are:
Solutions to support NSWO in 5GS;
Procedures to support authentication methods for the respective solutions in objective 1; and
Maintenance of privacy of subscription identifier, even for NSWO authentication from WLAN.

A PCT application No. PCT/CN2020/136618 as filed on 15 Dec. 2020 has proposed several alternatives to support Non-3GPP access authentication, which is incorporated herein in its entirety by reference. The alternatives may include:
Alt 1) SWa/SWx interworking with an entity for authentication in 5G Core (5GC), e.g., Unified Data Management (UDM), via an interworking/proxy entity, e.g., AAA-Interworking Function (IWF), and supporting EPC coexistence,
Alt 2) SWa/SWx interworking with e.g. UDM via another entity for authentication in 5GC, e.g., Authentication Server Function (AUSF), and EPC coexistence,
Alt 3) SWa interworking with e.g. AUSF via e.g. AAA-IWF and EPC coexistence,
Alt 4) Deployment of a Trusted Wireless Local Area Interworking Function (TWIF) as a Non-3GPP access point,
Alt 5) Deployment of a Trusted Non-3GPP Gateway Function (TNGF) as a Non-3GPP access point.

However, regarding the Alt 1) SWa/SWx interworking with the entity for authentication in 5GC via the interworking entity and EPC coexistence, the conventional technical solutions cannot support retrieval of authentication credentials based on a privacy protected subscriber identity (also called a ‘concealed identity’ throughout the description), e.g., Subscription Concealed Identifier (SUCI), in the Non-3GPP access authentication procedure. For example, the conventional technical solutions cannot handle a privacy protected subscriber identity in an entity for AAA, e.g., an AAA server; cannot handle the privacy protected subscriber identity over User data interworking, coexistence and migration (UDICOM) for EPC coexistence case; cannot handle retrieval of authentication credentials from an entity for authentication in 5GC (e.g., UDM) to an entity for authentication in EPC (e.g., HSS); and cannot determine the use of the privacy protected subscriber identity in the UE to be authenticated, etc.

The present disclosure thus designs several mechanisms to support the retrieval of authentication credentials based on the privacy protected subscriber identity in the Non-3GPP access authentication procedure.

The present disclosure may be applied in a Non-3GPP access authentication architecture in 5GC with EPS coexistence.

FIG. 2 schematically shows an exemplary Non-3GPP access authentication architecture in 5GC with EPS coexistence, in which exemplary embodiments of the present disclosure may be applied.

As shown in FIG. 2, a 3GPP AAA, also called a “3GPP AAA server”, (an example of an entity for AAA) may request authentication credentials (e.g., AVs for EAP AKA/EAP AKA′ or just called “AVs” for simplicity) for a UE to be authenticated from an HSS (an example of an entity for authentication in EPC) over an SWx/SWx′ interface (an example of a Diameter-based interface, wherein SWx is an example of a Diameter-based interface supporting a clear text identity, e.g., IMSI, of the UE, and SWx′ is an example of a Diameter-based interface supporting a concealed identity, e.g., SUCI, of the UE). If an authentication vector generation function for the UE is deployed in the HSS, the HSS may provide the AVs to the 3GPP AAA. If the authentication vector generation function for the UE has been moved to the UDM/Authentication Credential Repository and Processing Function (ARPF), the HSS may request the AVs from the UDM/ARPF over a UDICOM NU1 interface.

Alternatively, the 3GPP AAA may request authentication credentials (e.g., AVs for EAP AKA/EAP AKA′) from UDM/ARPF (an example of an entity for authentication in 5GC) via an AAA-IWF (an example of an interworking entity) over an SWx/SWx′ interface between 3GPP AAA and AAA-IWF/NSSAAF, and an N59 interface between AAA-IWF/NSSAAF and UDM/ARPF. The AAA-IWF may be realized by a Network Slice-Specific Authentication and Authorization Function (NSSAAF), and thus may also be represented as “AAA-IWF/NSSAAF”. If an authentication vector generation function for the UE is deployed in the UDM/ARPF, the UDM/ARPF may provide the AVs to the 3GPP AAA. If the authentication vector generation function for the UE has been moved to the HSS, the UDM/ARPF may request the AVs from the HSS over a UDICOM NU1 interface.

In scenarios where the Home Network supports a mixture of 4G only users, 5G users supporting interworking with EPC and 5G only users, an SLF/DRA (an example of a routing entity) may assists in routing the authentication vector requests from the 3GPP AAA towards the HSS (for 4G only users, 5G users supporting interworking with EPC) or towards the UDM/ARPF (for 5G only users) via the AAA-IWF/NSSAAF.

The 3GPP AAA may transmit the authentication vector requests over a Diameter-based interface (e.g., the SWx′ interface) supporting a concealed identity (e.g., SUCI) instead of a clear text identity (e.g., IMSI) of the UE.

The SLF/DRA may also assist in routing the authentication vector requests over the Diameter-based interface (which may also be called “Diameter commands”) towards the UDM/ARPF via the AAA-IWF/NSSAAF, e.g. based on the Diameter commands or the identity (e.g., SUCI or IMSI) of the UE.

The basic ideas of the present disclosure mainly consist in:
a standalone concealed identity de-concealment service, to enable the entity for AAA (e.g., the AAA server) to get a clear text subscriber identity, i.e., a de-concealed identity, from the entity for authentication in 5GC (e.g., the UDM) and proceed authentication e.g. for NSWO following the baseline procedure as defined in EPC;
an enhancement of Diameter-based and UDICOM-based services, to enable the entity for AAA or the entity for authentication in EPC (e.g., the HSS) to handle the concealed identity in the Diameter-based interface and the UDICOM interface and proceed authentication e.g. for NSWO following the baseline procedure as defined in EPC;
an enhancement of UDICOM-based services, to enable the entity for authentication in 5GC to fetch authentication credentials from the entity for authentication in EPC and then pass to the entity for AAA to enable the entity for AAA to proceed authentication e.g. for NSWO following the baseline procedure as defined in EPC; and
a scheme in which the UE to be authenticated may determine whether to activate UE identity privacy, e.g., based on at least one of: information from a Non-3GPP access element, e.g., a Non-3GPP AP, information provisioned from the home network of the UE, or configuration of the UE.

In particular, the present disclosure relates to improvements on a Non-3GPP access element, a UE to be authenticated, and various (CN) entities involved in a Non-3GPP access authentication procedure for the UE, in a scenario where 4G only users, 5G users supporting interworking with EPC, and 5G only users are supported.

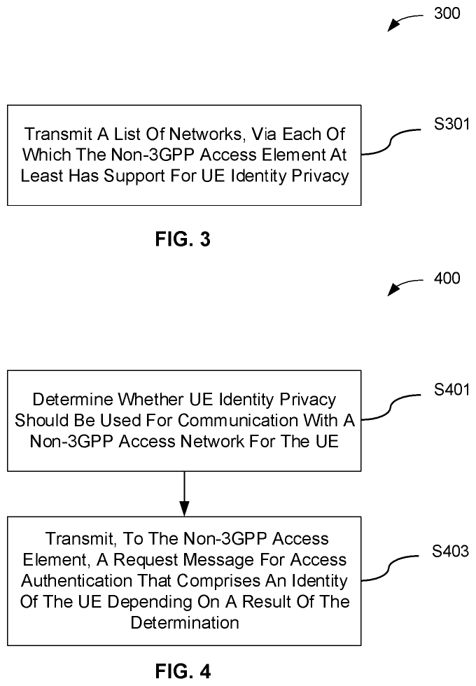

Hereinafter, the improvements proposed by the present disclosure on a Non-3GPP access element, a UE to be authenticated, and various (CN) entities involved in the Non-3GPP access authentication procedure for the UE will be described in detail in the following exemplary embodiments with reference to FIGS. 3˜24.

FIG. 3 schematically shows an exemplary method 300 performed by a Non-3GPP access element in a Non-3GPP access network for access authentication of a UE according to an exemplary embodiment of the present disclosure. For example, the Non-3GPP access element may be an Untrusted Non-3GPP AP, such as a WLAN AP, or a WLAN gateway etc.

As shown in FIG. 3, in step S301, the Non-3GPP access element may transmit, e.g., broadcast, a list of networks as specified in Clause 6.3.12 of 3GPP TS 23.501 v17.1.1, which is incorporated herein in its entirety by reference.

In addition to support for connectivity with an entity for AAA, e.g., a 3GPP AAA server, for access authentication, the Non-3GPP access element may have support for UE identity privacy via the networks in the list.

For example, the list of networks may be a list of PLMNs supporting not only the AAA connectivity for access authentication but also the UE identity privacy, e.g., for Non-3GPP access authentication.

Once a UE selects the Non-3GPP access network, i.e., the Non-3GPP access element, and selects a network (e.g., a PLMN) in the list broadcast by the Non-3GPP access element for performing 3GPP-based access authentication via this network, the UE may determine whether UE identity privacy should be used for communication with the Non-3GPP access network.

Thus in the method 300, the Non-3GPP access element may receive, from the UE, a request message for access authentication (e.g., EAP Response/Identity message) that includes a concealed identity, e.g., SUCI, of the UE, in a case where the UE determines that the UE identity privacy should be used. The concealed identity of the UE being received may comply with a Network Access Identifier (NAI) format as specified in 3GPP TS 23.003 v17.2.0.

Otherwise, in a case where the UE determines that the UE identity privacy should not be used, the Non-3GPP access element may receive, from the UE, a request message for access authentication that includes a clear text identity (also called “first identity” throughout the description), e.g., IMSI, of the UE.

Then in the method 300, the Non-3GPP access element may transmit a request message for authentication to a proper entity for AAA, e.g., based on a realm part of the NAI as specified in 3GPP TS 33.402 v16.0.0.

The request message for authentication transmitted by the Non-3GPP access element may include the identity of the UE obtained from the received request message for access authentication. Alternatively, the request message for authentication may also include an access network identity of the Non-3GPP access network, e.g., ANID.

Correspondingly, FIG. 4 schematically shows an exemplary method 400 performed by a UE for access authentication according to an exemplary embodiment of the present disclosure. It should be understood that the method 400 performed by the UE at least partly corresponds to the method 300 performed by the Non-3GPP access element. Thus, some description of the method 400 may refer to that of method 300 as previously described, and thus will be omitted here for simplicity.

As previously described, the UE may select a Non-3GPP access network, i.e., the Non-3GPP access element, and selects a network (e.g., a PLMN) in the list broadcast by the Non-3GPP access element for performing 3GPP-based access authentication via this network.

Then in step S401, the UE may determine whether UE identity privacy should be used for communication with the selected Non-3GPP access network. In an exemplary embodiment, the communication with the Non-3GPP access network may include NSWO from the Non-3GPP access network for the UE.

In an exemplary embodiment, the UE may determine whether UE identity privacy should be used for communication with the Non-3GPP access network for the UE based on at least one of:
configuration of the UE;
information about the Non-3GPP access element in the Non-3GPP access network; or
information about a home network of the UE.

In an exemplary embodiment, the UE may obtain the configuration of the UE by receiving or preconfiguring the configuration of the UE. The configuration of the UE may include information indicating whether the UE has support for the UE identity privacy.

In an exemplary embodiment, the UE may obtain the information about the Non-3GPP access element by receiving, from the Non-3GPP access element, the information about the Non-3GPP access element indicating whether the Non-3GPP access element has support for the UE identity privacy. The information about the Non-3GPP access element may include a list of networks, e.g., a list of PLMNs, as previously described, via each of which the Non-3GPP access element may have not only the support for the connectivity with an entity for AAA, e.g., a 3GPP AAA server, for access authentication but also the support for the UE identity privacy.

In an exemplary embodiment, the UE may obtain the information about the home network of the UE by receiving, from the home network, the information about the home network indicating whether the home network has support for the UE identity privacy.

The information about the home network indicating whether the home network has support for the UE identity privacy may be carried in a UE UPU procedure or a SoR procedure as defined in 3GPP TS 33.501 v17.2.1.

The support for the UE identity privacy may include support for the UE identity privacy for Non-3GPP access authentication.

After the UE determines whether the UE identity privacy should be used, the UE may transmit a request message for access authentication to the Non-3GPP access element depending on a result of the determination in step S403. The request message for access authentication may include an identity of the UE. The UE may transmit its identity complying with the NAI format as specified in 3GPP TS 23.003 v17.2.0.

In particular, if the UE determines that the UE identity privacy should be used, the request message for access authentication may include a concealed identity, e.g., SUCI, of the UE in NAI.

Otherwise, if the UE determines that the UE identity privacy should not be used, the request message for access authentication may include a first identity, e.g., IMSI, of the UE in NAI.

After the Non-3GPP access element transmits the request message for authentication including the identity of the UE to the entity for AAA, various (CN) entities may cooperate to perform the Non-3GPP access authentication of the UE, in a scenario where 4G only users, 5G users supporting interworking with EPC, and 5G only users are supported.

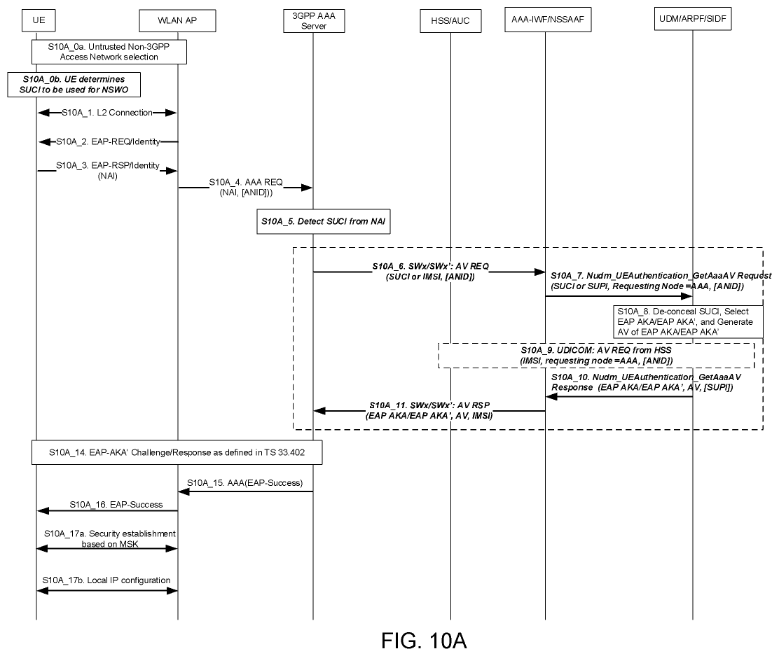

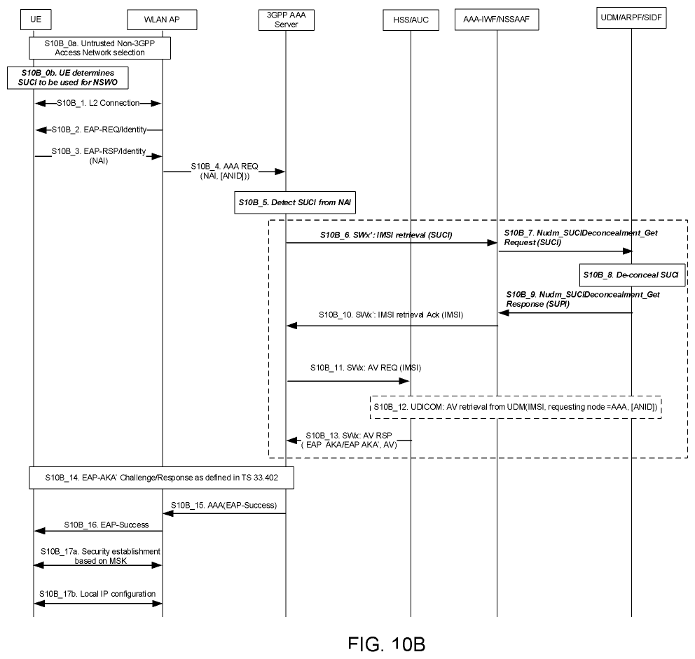

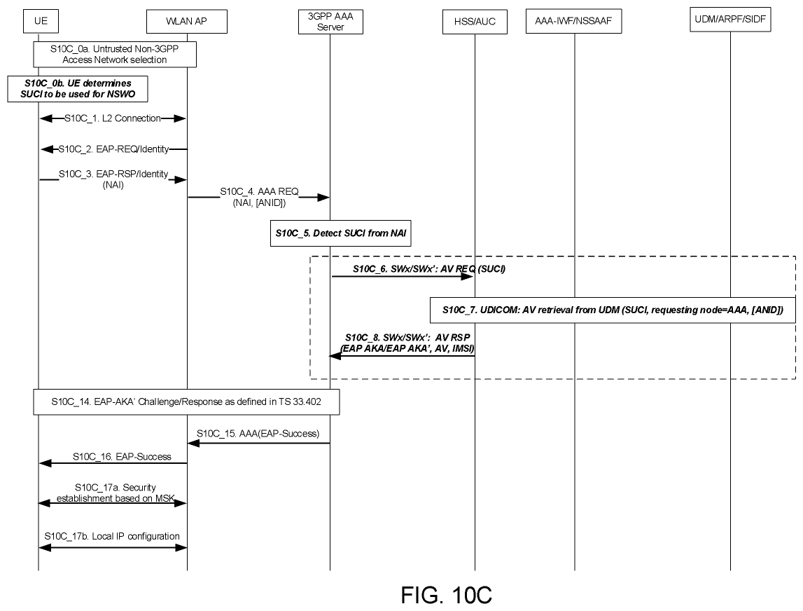

Regarding the methods performed by various (CN) entities for the Non-3GPP access authentication of the UE in a scenario where 4G only users, 5G users supporting interworking with EPC, and 5G only users are supported, the present disclosure proposes at least three exemplary embodiments, exemplary signaling sequence diagrams of which are respectively shown in FIGS. 10A˜10C, which will be described in detail later.

It may be understood that the methods performed by the UE and the Non-3GPP access element as previously described with reference to FIGS. 3 and 4 are identical for the at least three exemplary embodiments.

In the first exemplary embodiment, authentication credentials (e.g., an authentication method, an authentication vector etc.) for the UE may be retrieved from an entity for authentication in 5GC via an interworking entity.

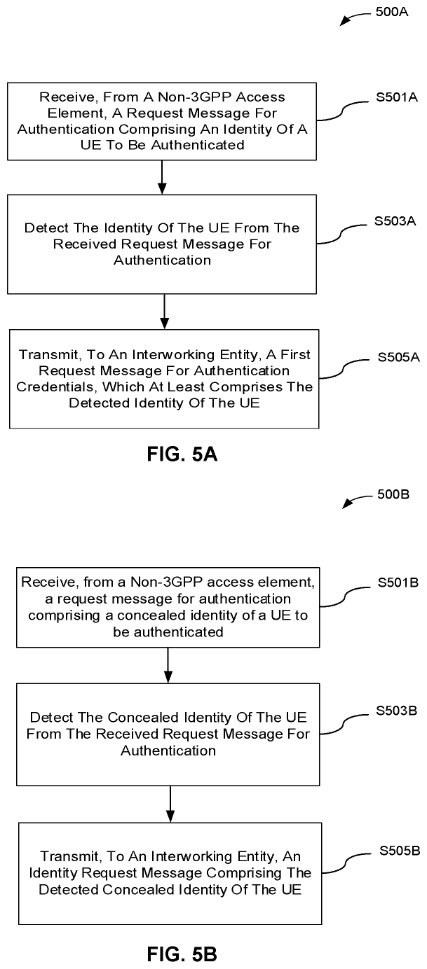

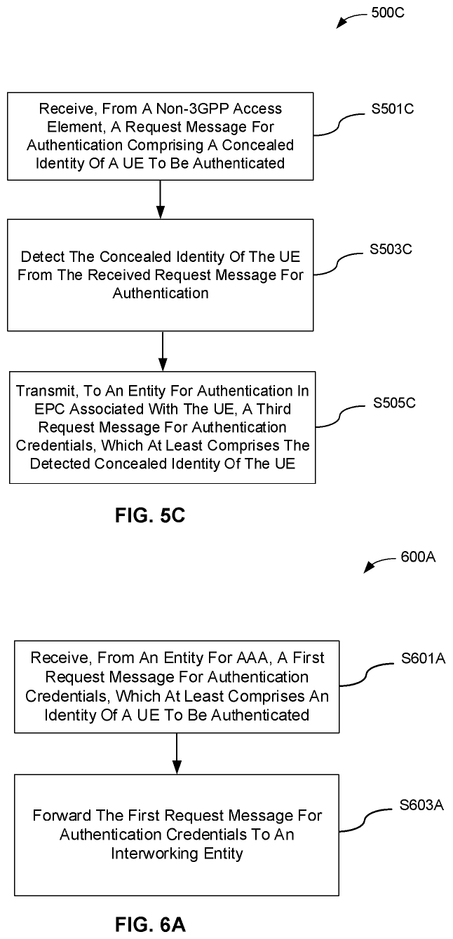

Hereinafter, methods for Non-3GPP access authentication of the UE performed by an entity for AAA, a routing entity, an interworking entity, an entity for authentication in 5GC, and an entity for authentication in EPC according to the first exemplary embodiment will be described with reference to FIGS. 5A, 6A, 7A, 8A, and 9A, respectively.

FIG. 5A schematically shows an exemplary method 500A performed by the entity for AAA according to the first exemplary embodiment of the present disclosure. It should be understood that the entity for AAA may be a 3GPP AAA server, or any other entity that may be configured to perform the method 500A as described below, including a virtualized entity that may be implemented on cloud.

In step S501A, the entity for AAA may receive a request message for authentication from a Non-3GPP access element.

The request message for authentication received from the Non-3GPP access network may include an identity of the UE to be authenticated. As previously described, the identity of the UE may include a concealed identity, e.g., SUCI, of the UE or a first identity, e.g., IMSI, of the UE, which depends on the determination result of the UE on whether the UE identity privacy should be used for communication with the Non-3GPP access network, and may be contained in NAI carried by the request message for access authentication from the UE to the Non-3GPP access network, and/or the request message for authentication from the Non-3GPP access network to the entity for AAA.

As previously described, the request message for authentication may also include an access network identity of the Non-3GPP access network, e.g., ANID.

Then, the entity for AAA may detect the identity of the UE from the received request message for authentication in step S503A.

In a case where the identity of the UE in the received request message for authentication includes the concealed identity, e.g., SUCI, of the UE, the concealed identity of the UE may be detected by the entity for AAA.

In a case where the identity of the UE in the received request message for authentication includes the first identity, e.g. IMSI, of the UE, or the concealed identity, SUCI, of the UE that is protected with a Null Scheme, the first identity, e.g., IMSI, of the UE may be detected by the entity for AAA.

Then, the entity for AAA may transmit a first request message for authentication credentials to an interworking entity in step S505A. The first request message for authentication credentials may at least include the detected identity of the UE.

In a case where the detected identity of the UE is the concealed identity, e.g., SUCI, of the UE, the first request message for authentication credentials may be transmitted to the interworking entity over a Diameter-based interface, e.g., an enhancement to the SWx interface (represented by SWx′), supporting the concealed identity (e.g., SUCI) of the UE.

For example, the first request message for authentication credentials may be an enhancement to SWx messages, such as

Multimedia-Auth-Request/Multimedia-Auth-Answer, as specified in 3GPP TS 33.402 v16.0.0.

In a case where the detected identity of the UE is the first identity, e.g., IMSI, of the UE, the first request message for authentication credentials may be transmitted to the interworking entity over a Diameter-based interface, e.g., the existing SWx interface, supporting the first identity, e.g., IMSI, of the UE.

Alternatively, the first request message for authentication credentials may further include the access network identity related to the Non-3GPP access element, e.g., ANID.

In an exemplary embodiment, the first request message for authentication credentials may be transmitted to the interworking entity via a routing entity, e.g., SLF/DRA.

It may be understood that the routing entity may be optional. In absence of a separate routing entity, the corresponding routing function may be implemented by the entity for AAA.

After the interworking entity obtains the authentication credentials from the entity for authentication in 5GC, the entity for AAA may receive a first response message for authentication credentials from the interworking entity.

The first response message for authentication credentials may include:
an authentication method, e.g., EAP AKA/EAP AKA′ selected by an entity for authentication in 5GC associated with the UE or requested by the entity for authentication in 5GC from an entity for authentication in EPC associated with the UE,
an authentication vector generated by the entity for authentication in 5GC or requested by the entity for authentication in 5GC from the entity for authentication in EPC, and
a first identity, e.g., IMSI, of the UE obtained from the detected identity of the UE.

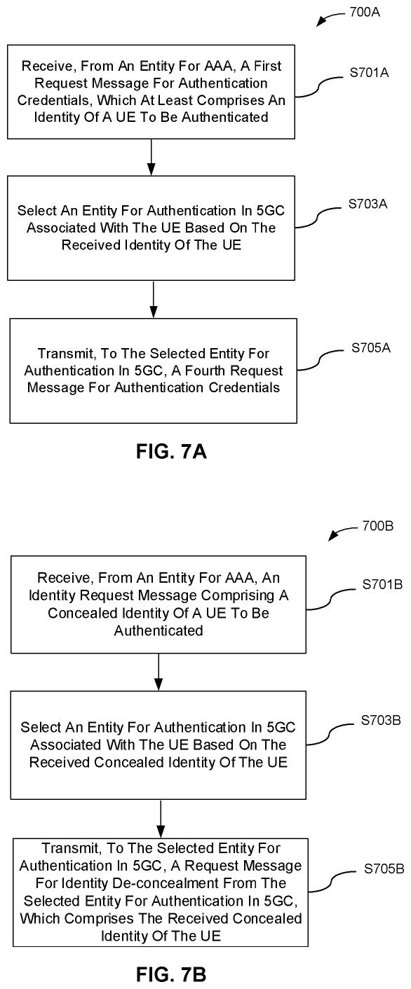

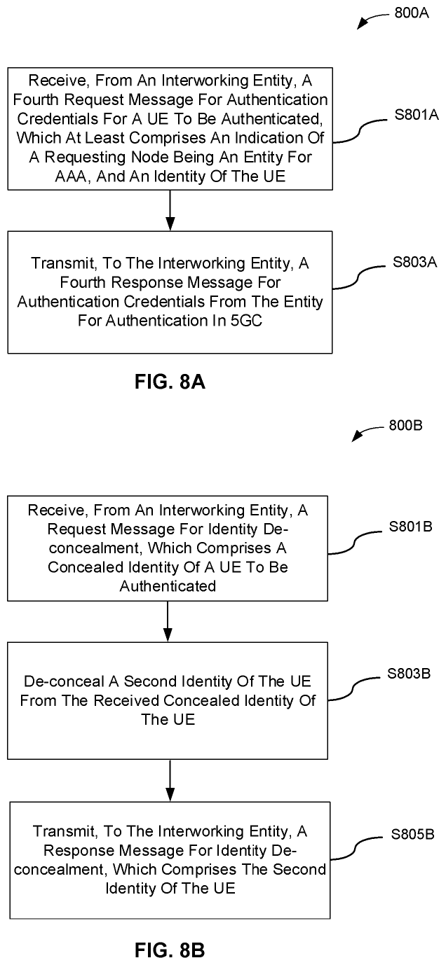

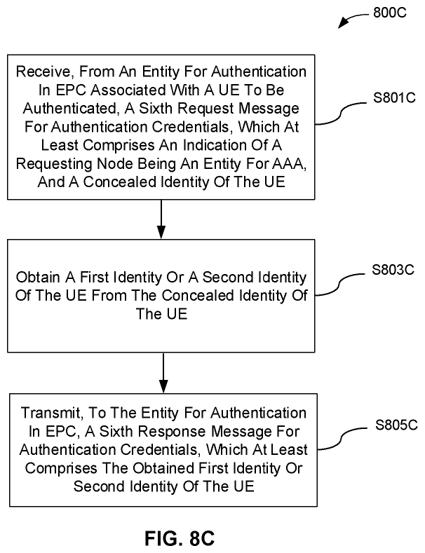

The details regarding how to obtain the authentication credentials, such as the authentication method, the authentication vector of the UE, and the first identity, e.g., IMSI, of the UE will be described later in the method 700A performed by the interworking entity with reference to FIG. 7A and the method 800A performed by the entity for authentication in 5GC with reference to FIG. 8A.

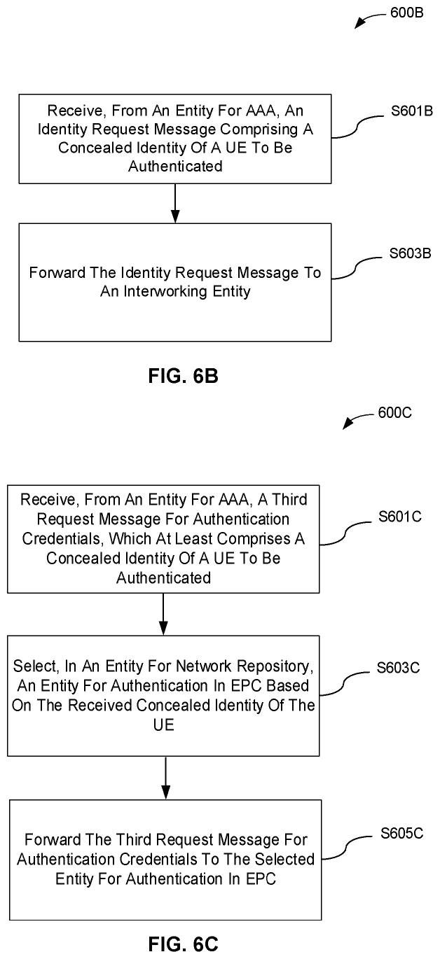

FIG. 6A schematically shows an exemplary method 600A performed by a routing entity according to the first exemplary embodiment of the present disclosure. It should be understood that the routing entity may be an SLF/DRA, or any other entity that may be configured to perform the method 600A as described below, including a virtualized entity that may be implemented on cloud.

It should also be understood that the method 600A performed by the routing entity at least partly corresponds to the method 500A performed by the entity for AAA. Thus, some description of the method 600A may refer to that of method 500A as previously described, and thus will be omitted here for simplicity.

In step S601A, the routing entity may receive a first request message for authentication credentials from the entity for AAA, e.g., 3GPP AAA sever.

As previously described, the first request message for authentication credentials may at least include the identity of the UE to be authenticated. The identity of the UE may include a concealed identity, e.g., SUCI, of the UE or a first identity, e.g., IMSI, of the UE.

Alternatively, the first request message for authentication credentials may further include the access network identity related to the Non-3GPP access element, e.g., ANID.

In step S603A, the routing entity may forward the first request message for authentication credentials to an interworking entity, e.g., AAA-IWF/NSSAAF.

That is, the routing entity may assist in routing the first request message for authentication credentials towards the entity for authentication in 5GC via the interworking entity.

In a case where the identity of the UE includes the concealed identity, e.g., SUCI, of the UE, the first request message for authentication credentials may be received and forwarded over a Diameter-based interface, e.g., an SWx′ interface, supporting the concealed identity, e.g., SUCI, of the UE. In a case where the identity of the UE includes the first identity, e.g., IMSI, of the UE, the first request message for authentication credentials may be received and forwarded over a Diameter-based interface e.g., an SWx interface, supporting the first identity, e.g., IMSI, of the UE.

After the interworking entity obtains the authentication credentials from the entity for authentication in 5GC, the routing entity may receive the first response message for authentication credentials from the interworking entity, and forward the first response message for authentication credentials to the entity for AAA.

As previously described, the first response message for authentication credentials may include:
an authentication method, e.g., EAP AKA/EAP AKA′ selected by an entity for authentication in 5GC associated with the UE or requested by the entity for authentication in 5GC from an entity for authentication in EPC associated with the UE,
an authentication vector generated by the entity for authentication in 5GC or requested by the entity for authentication in 5GC from the entity for authentication in EPC, and
a first identity, e.g., IMSI, of the UE obtained from the identity of the UE.

As described previously, the details regarding how to obtain the authentication credentials, such as the authentication method, the AV, and the first identity, e.g., IMSI, of the UE will be described later in the method 700A performed by the interworking entity with reference to FIG. 7A and the method 800A performed by the entity for authentication in 5GC with reference to FIG. 8A.

It may be understood that although the method 600A performed by the routing entity is described here separately, it may be performed by the entity for AAA in absence of a separate routing entity.

FIG. 7A schematically shows an exemplary method 700A performed by an interworking entity according to the first exemplary embodiment of the present disclosure. It should be understood that the interworking entity may be an AAA-IWF/NSSAAF, or any other entity that may be configured to perform the method 700A as described below, including a virtualized entity that may be implemented on cloud.

It should also be understood that the method 700A performed by the interworking entity at least partly corresponds to the method 500A performed by the entity for AAA, and optionally, the method 600A performed by the routing entity. Thus, some description of the method 700A may refer to that of method 500A, and optionally, that of method 600A as previously described, and thus will be omitted here for simplicity.

In step S701A, the interworking entity may receive a first request message for authentication credentials from an entity for AAA, e.g., 3GPP AAA sever.

As previously described, the first request message for authentication credentials may at least include the identity of the UE to be authenticated. The received identity of the UE may include a concealed identity (e.g., SUCI) of the UE or a first identity (e.g., IMSI) of the UE.

Alternatively, the first request message for authentication credentials may further include the access network identity related to the Non-3GPP access element, e.g., ANID.

As previously described, the first request message for authentication credentials may be received from the entity for AAA via the routing entity.

Then in step S703A, the interworking entity may select an entity for authentication in 5GC, e.g., UDM, associated with the UE, based on the received identity of the UE.

In step S705A, the interworking entity may transmit a fourth request message for authentication credentials to the selected entity for authentication in 5GC.

In an exemplary embodiment, the fourth request message for authentication credentials may be a new Service-Based Interface (SBI) request message for authentication credentials that is translated by the interworking entity from the first request message for authentication credentials over the Diameter-based interface, e.g., an SWx/SWx′ interface.

In a case where the received identity of the UE includes the concealed identity, e.g., SUCI, of the UE, the interworking entity may receive the first request message for authentication credentials in step S701A over a Diameter-based interface (e.g., an SWx′ interface) supporting the concealed identity, e.g., SUCI, of the UE. Then, the interworking entity may select the entity for authentication in 5GC in step S703A, based on a routing indicator included in the received concealed identity, e.g., SUCI, of the UE. Next, the interworking entity may transmit to the selected entity for authentication in 5GC in step S705A the fourth request message for authentication credentials, wherein the fourth request message for authentication credentials may at least include an indication of a requesting node being the entity for AAA and the concealed identity, e.g., SUCI, of the UE.

In a case where the received identity of the UE includes the first identity, e.g., IMSI, of the UE, the interworking entity may receive the first request message for authentication credentials in step S701A over a Diameter-based interface (e.g., an SWx interface) supporting the first identity, e.g., IMSI, of the UE. Then, the interworking entity may select the entity for authentication in 5GC in step S703A, based on the first identity, e.g., IMSI, of the UE. Next, the interworking entity may transmit to the selected entity for authentication in 5GC in step S705A the fourth request message for authentication credentials, wherein the fourth request message for authentication credentials may at least include an indication of a requesting node being the entity for AAA and another clear text identity (also called “second identity” throughout the description), e.g., SUPI, of the UE that may be converted by the interworking entity from the first identity, e.g., IMSI, of the UE.

Alternatively, in either of the above two cases, the fourth request message for authentication credentials may further include an access network identity, e.g., ANID, related to the Non-3GPP access element to which the UE is connected.

After the selected entity for authentication in 5GC obtains the corresponding authentication credentials, the interworking entity may receive a fourth response message for authentication credentials from the selected entity for authentication in 5GC.

The fourth response message for authentication credentials may at least include:
an authentication method selected by the selected entity for authentication in 5GC or requested by the selected entity for authentication in 5GC from an entity for authentication in EPC, e.g., HSS, associated with the UE, and
an authentication vector generated by the selected entity for authentication in 5GC or requested by the selected entity for authentication in 5GC from the entity for authentication in EPC.

It may be understood that in the case where the received identity of the UE in the first request message for authentication credentials includes the first identity, e.g., IMSI, of the UE, the fourth response message for authentication credentials may not include the second identity, e.g., SUPI, of the UE, since the interworking entity has known the first identity, e.g., IMSI, of the UE.

Alternatively, the fourth response message for authentication credentials may further include the second identity, e.g., SUPI, of the UE, which may be de-concealed by the entity for authentication in 5GC from the concealed identity, e.g., SUCI, of the UE, in the case where the received identity of the UE in the first request message for authentication credentials includes the concealed identity, e.g., SUCI, of the UE; or may be the one that is converted by the interworking entity from the received first identity, e.g., IMSI, of the UE, in the case where the received identity of the UE in the first request message for authentication credentials includes the first identity, e.g., IMSI, of the UE.

Then, the interworking entity may transmit a first response message for authentication credentials to the entity for AAA.

As previously described, the first response message for authentication credentials may include:
the authentication method, e.g., EAP AKA/EAP AKA′ selected by the entity for authentication in 5GC or requested by the entity for authentication in 5GC from an entity for authentication in EPC associated with the UE,
the authentication vector generated by the selected entity for authentication in 5GC or requested by the selected entity for authentication in 5GC from the entity for authentication in EPC, and
the first identity of the UE obtained from the received identity of the UE.

In the exemplary embodiment where the fourth response message for authentication credentials received from the selected entity for authentication in 5GC includes the second identity, e.g., SUPI, of the UE as previously described, the interworking entity may convert the second identity, e.g., SUPI, of the UE into the first identity, e.g., IMSI, of the UE, and include the first identity, e.g., IMSI, of the UE in the first response message for authentication credentials.

In the exemplary embodiment where the interworking entity has known the first identity, e.g., IMSI, of the UE in the case where the received identity of the UE in the first request message for authentication credentials includes the first identity, e.g., IMSI, of the UE, the fourth response message for authentication credentials received from the selected entity for authentication in 5GC may not include the second identity, e.g., SUPI, of the UE as previously described, and the interworking entity may directly include the first identity, e.g., IMSI, of the UE in the first response message for authentication credentials.

FIG. 8A schematically shows an exemplary method 800A performed by an entity for authentication in 5GC according to the first exemplary embodiment of the present disclosure. It should be understood that the entity for authentication in 5GC may be a UDM/ARPF/Subscription Identifier De-concealing Function (SIDF), or any other entity that may be configured to perform the method 800A as described below, including a virtualized entity that may be implemented on cloud.

It should also be understood that the method 800A performed by the entity for authentication in 5GC at least partly corresponds to the method 700A performed by the interworking entity. Thus, some description of the method 800A may refer to that of method 700A, and thus will be omitted here for simplicity.

In step S801A, the entity for authentication in 5GC may receive a fourth request message for authentication credentials for a UE to be authenticated from an interworking entity.

As previously described, the fourth request message for authentication credentials may at least include an indication of a requesting node being an entity for AAA, and an identity of the UE. The identity of the UE may include a concealed identity, e.g., SUCI, of the UE or a second identity, e.g., SUPI, of the UE. Alternatively, the fourth request message for authentication credentials may further include an access network identity, e.g., ANID, related to the Non-3GPP access element to which the UE is connected.

In the case where the received identity of the UE includes the concealed identity, e.g., SUCI, of the UE, the entity for authentication in 5GC may de-conceal a second identity, e.g., SUPI, of the UE from the received concealed identity, e.g., SUCI, of the UE.

Then, the entity for authentication in 5GC may select an authentication method, e.g., EAP AKA/EAP AKA′, for the UE at least based on the indication of the requesting node being the entity for AAA and the second identity, e.g., SUPI, of the UE. The selection of EAP AKA′ for the UE may be further based on the access network identity, e.g., ANID, related to the Non-3GPP access element to which the UE is connected.

And the entity for authentication in 5GC may generate an authentication vector for the UE at least based on the second identity, e.g., SUPI, of the UE.

It may be understood that in the case where the received identity of the UE includes the second identity, e.g., SUPI, of the UE that is converted from the first identity, e.g., IMSI, of the UE by the interworking entity, the entity for authentication in 5GC may directly use the second identity, e.g., SUPI, of the UE for selecting the authentication method and generating the authentication vector without the de-concealment.

In an exemplary embodiment, the authentication vector generation function for the UE may be deployed in the entity for authentication in EPC, e.g., HSS, associated with the UE. In this case, the entity for authentication in 5GC may request the corresponding authentication credentials from the entity for authentication in EPC.

In particular, the entity for authentication in 5GC may transmit a fifth request message for authentication credentials to the entity for authentication in EPC. The fifth request message for authentication credentials may at least include: the indication of the requesting node being the entity for AAA, and the identity of the UE. Here, the identity of the UE may include the second identity, e.g., SUPI, of the UE, or may include the first identity, e.g., IMSI, of the UE that may be converted by the entity for authentication in 5GC.

Alternatively, the fifth request message for authentication credentials may further include an access network identity, e.g., ANID, of the Non-3GPP access network to which the UE is connected.

Then, the entity for authentication in 5GC may receive a fifth response message for authentication credentials from the entity for authentication in EPC. The fifth response message for authentication credentials may at least include an authentication method for the UE and an authentication vector for the UE.

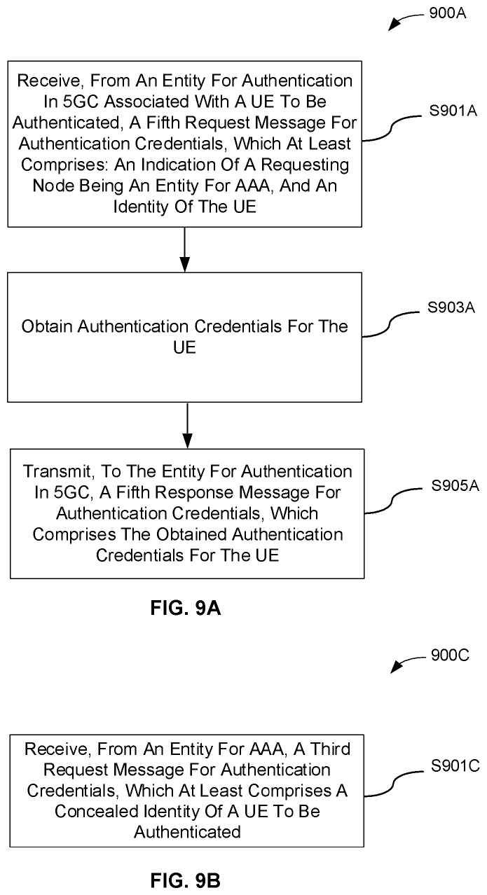

The details regarding how to obtain the authentication credentials, such as the authentication method, the AV, of the UE by the entity for authentication in EPC will be described later in the method 900A performed by the entity for authentication in EPC with reference to FIG. 9A.

After the entity for authentication in 5GC obtains the authentication credentials, such as the authentication method, the AV, for the UE, the entity for authentication in 5GC may include the authentication credentials in a fourth response message for authentication credentials, and transmit the fourth response message for authentication credentials to the interworking entity in step S803A.

FIG. 9A schematically shows an exemplary method 900A performed by an entity for authentication in EPC according to the first exemplary embodiment of the present disclosure. It should be understood that the entity for authentication in EPC may be an HSS/Authentication Center (AUC), or any other entity that may be configured to perform the method 900A as described below, including a virtualized entity that may be implemented on cloud.

It should also be understood that the method 900A performed by the entity for authentication in EPC at least partly corresponds to the method 800A performed by the entity for authentication in 5GC. Thus, some description of the method 900A may refer to that of method 800A, and thus will be omitted here for simplicity.

As previously described, the method 900A is performed by the entity for authentication in EPC, if the authentication vector generation function for the UE is deployed in the entity for authentication in EPC. In this case, the entity for authentication in 5GC may request the corresponding authentication credentials from the entity for authentication in EPC.

In step S901A, the entity for authentication in EPC may receive a fifth request message for authentication credentials from the entity for authentication in 5GC associated with the UE to be authenticated.

As previously described, the fifth request message for authentication credentials may at least include: an indication of a requesting node being an entity for AAA, and an identity of the UE. The identity of the UE may include a second identity, e.g., SUPI, of the UE, or may include a first identity, e.g., IMSI, of the UE that may be converted by the entity for authentication in 5GC.

Alternatively, the fifth request message for authentication credentials may further include an access network identity, e.g., ANID, of the Non-3GPP access network to which the UE is connected.

Then in step S903A, the entity for authentication in EPC may obtain authentication credentials for the UE. The authentication credentials for the UE may include: an authentication method, e.g., EAP AKA/EAP AKA′, for the UE and an authentication vector for the UE.

In particular, in step S903A, the entity for authentication in EPC may select an authentication method for the UE at least based on the indication of the requesting node being the entity for AAA and the identity, e.g., SUPI or IMSI, of the UE, and may generate an authentication vector for the UE at least based on the identity, e.g., SUPI or IMSI, of the UE.

Then in step S905A, the entity for authentication in EPC may include the obtained authentication credentials for the UE in a fifth response message for authentication credentials, and transmit the fifth response message for authentication credentials to the entity for authentication in 5GC.

Hereinafter, a Non-3GPP access authentication for a UE according to the first exemplary embodiment of the present disclosure will be described with reference to an exemplary signaling sequence diagram as shown in FIG. 10A, in which the methods of FIGS. 3, 4, 5A, 6A, 7A, 8A and 9A may be applied.

Some description of the exemplary signaling sequence diagram as shown in FIG. 10A may refer to that of methods 300, 400, 500A, 600A, 700A, 800A and 900A as previously described, and thus will be omitted here for simplicity.

In the following description on the exemplary signaling sequence diagram of FIG. 10A, a WLAN AP is illustrated as an example of the Non-3GPP access element as previously described, a 3GPP AAA server is illustrated as an example of the entity for AAA, an SLF/DRA (not shown) is illustrated as an example of the routing entity, an AAA-IWF/NSSAAF is illustrated as an example of the interworking entity, a UDM/ARPF/SIDF is illustrated as an example of the entity for authentication in 5GC, and an HSS/AUC is illustrated as an example of the entity for authentication in EPC.

It should be understood that the above exemplary entities are only used here for illustration but without any limitation. Respective entities other than those mentioned here or any combination thereof may cooperate to perform the Non-3GPP access authentication for the UE, as long as the methods 300, 500A, 600A, 700A, 800A and 900A may be implemented respectively.

It should be noted that the description below mainly focuses on signaling related to the methods 300, 400, 500A, 600A, 700A, 800A and 900A, and some other signaling is not described in detail to avoid obscuring the principle of the present disclosure. In FIG. 10A, modification on the signaling related to the methods 300, 400, 500A, 600A, 700A, 800A and 900A is shown in Bold Italics, in which e.g., Signaling S10A_Ob, S10A_5˜S10A_7, and S10A_9˜S10A_11 are involved.

In S10A_Oa, the UE may select a WLAN access network and a PLMN for performing 3GPP based access authentication via this PLMN.

During this procedure, the WLAN AP in the WLAN access network may broadcast a PLMN List as specified in Clause 6.3.12 of 3GPP TS 23.501 v17.1.1. The WLAN AP may broadcast a PLMN List which includes all the PLMNs via which the WLAN access network may support connectivity with a 3GPP AAA server for access authentication and UE identity privacy (e.g., SUCI).

In S10A_Ob, the UE may determine whether the UE identity privacy should be used for e.g., NSWO traffic, e.g., based on the local configuration, the information from WLAN AP, and the information provisioned by the home network that the home network supports UE identity privacy for access authentication e.g., for NSWO. The provision of such information may be carried in a UE UPU procedure or a SoR procedure as defined in 3GPP TS 33.501 v17.2.1.

In S10A_1, a layer-2 connection may be established between the UE and the WLAN access network.

In S10A_2, the WLAN access network, e.g., the EAP authenticator in the WLAN access network, may transmit an EAP Request/Identity to the UE.

In S10A_3, the UE may transmit an EAP Response/Identity message to the WLAN access network, i.e., the WLAN AP. The UE shall transmit its identity complying with the NAI format as specified in 3GPP TS 23.003 v17.2.0.

In a case where the UE determines that the UE identity privacy should be used, the NAI contains either a pseudonym allocated to the UE in a previous run of the authentication procedure, or the SUCI in the case of first authentication.

Then in S10A_4, the WLAN AP may transmit an AAA request message towards a proper 3GPP AAA Server, e.g., based on a realm part of the NAI as specified in 3GPP TS 33.402 v16.0.0. The routing path may include one or several AAA proxies. In such cases, the NAI of SUCI may be formed in decorated NAI format as specified in in 3GPP TS 23.003 v17.2.0. The AAA request message transmitted by the WLAN AP may include the SUCI or IMSI in the NAI and optionally, an ANID of the WLAN access network.

In S10A_5, the 3GPP AAA Server may receive the AAA request message that contains the identity of the UE. In the case where the UE determines to use SUCI, the AAA request message may include a SUCI in the NAI format, and the 3GPP AAA may detect the SUCI from the NAI.

The 3GPP AAA may determine to retrieve authentication credentials, such as EAP AKA/EAP AKA′, AVs, for the UE over SWx (in case of IMSI being detected) or SWx′ (in case of SUCI being detected).

In the case where the UE determines to use IMSI, the AAA request message may include an IMSI in the NAI format, and the 3GPP AAA may detect the IMSI from the NAI, and may determine to retrieve the authentication credentials from the HSS/AUC via SWx as in the existing EPC procedure (with UDICOM).

In S10A_6, the 3GPP AAA Server may transmit an AV Request message for retrieving the authentication credentials from the UDM/ARPF/SIDF via AAA-IWF/NSSAAF. The AV Request message may include SUCI or IMSI, and optionally, the ANID.

In case of SUCI being detected, the 3GPP AAA Server may create an updated Diameter SWx′ request message as the AV Request message. This message may be an enhancement to SWx messages, e.g. Multimedia-Auth-Request/Multimedia-Auth-Answer, as specified in 3GPP TS 33.402 v16.0.0. Otherwise, in case of IMSI being detected, the existing Diameter SWx Multimedia-Auth-Request (MAR) commands may be used as defined.

An optional SLF/DRA (not shown) may assist in routing the updated Diameter SWx/SWx′ requests towards a UDM/ARPF/SIDF via the AAA-IWF/NSSAAF.

In S10A_7, the AAA-IWF/NSSAAF may discover and select an UDM/ARPF/SIDF e.g. based on the routing identifier of the SUCI. The AAA-IWF/NSSAAF may translate the SWx′/SWx AV Request message to a new SBI AV Request message, e.g. Nudm_UEAuthentication_GetAaaAV, which may include the SUCI (in case of SUCI being received) or a SUPI converted by the AAA-IWF/NSSAAF from IMSI (in case of SUCI being received), an indication of the requesting node being the 3GPP AAA server, and optionally, the ANID. The AAA-IWF/NSSAAF may transmit the SBI AV Request message to the selected UDM/ARPF/SIDF.

In S10A_8, the UDM/ARPF/SIDF may de-conceal the SUPI from the SUCI (in case of SUCI being received). The UDM/ARPF/SIDF may select an EAP AKA as an authentication method, e.g. at least based on the SUPI of the UE (de-concealed in case of SUCI being received, or directly received), and the indication of the requesting node being the 3GPP AAA server, or select an EAP AKA′ as an authentication method, e.g. at least based on the UE's subscription, the ANID, and the indication of the requesting node being the 3GPP AAA server. The UDM/ARPF/SIDF may generate AVs of EAP-AKA/EAP-AKA′ at least based on the SUPI of the UE.

Alternatively, if the authentication vector generation function (for this user) is deployed in HSS/AUC, in S10A_9, the UDM/ARPF/SIDF may transmit an AV Request message for the corresponding authentication credentials to the HSS/AUC using a new service operation of UDICOM NU1 reference point. The AV Request message may include the SUPI or the IMSI that may be converted by the UDM/ARPF/SIDF, an indication of a requesting node being the 3GPP AAA server, and optionally, the ANID. Then, the UDM/ARPF/SIDF may receive the corresponding authentication credentials from the HSS/AUC.

In S10A_10, the UDM/ARPF/SIDF may transmit an AV Response message to the AAA-IWF/NSSAAF with the selected authentication credentials and optionally, the SUPI.

In S10A_11, the AAA-IWF/NSSAAF may convert the SUPI into the IMSI (in case of SUPI being received), and transmit an AV Response message to the 3GPP AAA server over SWx/SWx′ with the selected authentication credentials and IMSI.

Then in S10A_14, the 3GPP AAA server and the UE may proceed with an EAP AKA′ procedure and derive key materials e.g. MSK/EMSK as specified in 3GPP TS 33.402 v16.0.0.

In S10A_15, the 3GPP AAA Server may transmit the EAP Success message and the MSK to the authenticator in the WLAN access network.

In S10A_16, the authenticator in the WLAN access network may inform the UE about the successful authentication with the EAP Success message. In S10A_17a, the UE and the WLAN access network may proceed with security establishment based on the share keying material.

In S10A_17b, after successful authentication, the UE may receive its IP configuration from the WLAN access network and can exchange IP data traffic directly via the WLAN, i.e. using NSWO.

In the second exemplary embodiment, authentication credentials (e.g., an authentication method, an authentication vector etc.) for the UE may be retrieved from an entity for authentication in EPC based on a first identity, e.g. IMSI, of the UE that is de-concealed from an entity for authentication in 5GC. Hereinafter, methods for Non-3GPP access authentication of the UE performed by an entity for AAA, a routing entity, an interworking entity, and an entity for authentication in 5GC according to the second exemplary embodiment will be described with reference to FIGS. 5B, 6B, 7B, and 8B, respectively.

FIG. 5B schematically shows an exemplary method 500B performed by the entity for AAA according to the second exemplary embodiment of the present disclosure. It should be understood that the entity for AAA may be a 3GPP AAA server, or any other entity that may be configured to perform the method 500B as described below, including a virtualized entity that may be implemented on cloud.

In step S501B, the entity for AAA may receive a request message for authentication from a Non-3GPP access element.

The request message for authentication received from the Non-3GPP access network may include an identity of the UE to be authenticated. The identity of the UE may include a concealed identity, e.g., SUCI, of the UE, which depends on the determination result of the UE on that the UE identity privacy should be used for communication with the Non-3GPP access network, and may be contained in NAI carried by the request message for access authentication from the UE to the Non-3GPP access network, and/or the request message for authentication from the Non-3GPP access network to the entity for AAA.

Then, the entity for AAA may detect the concealed identity, e.g., SUCI, of the UE from the received request message for authentication in step S503B.

Then in step S505B, the entity for AAA may transmit to an interworking entity, e.g., AAA-IWF/NSSAAF, an identity request message for retrieving a de-concealed identity (also called a “first identity”), e.g., IMSI, of the UE. The identity request message may include the detected concealed identity, e.g., SUCI, of the UE. The identity request message may be transmitted over a Diameter-based interface, e.g., an SWx′ interface, supporting the concealed identity, e.g., SUCI, of the UE.

In an exemplary embodiment, the identity request message may be transmitted to the interworking entity via a routing entity, e.g., SLF/DRA.

It may be understood that the routing entity may be optional. In absence of a separate routing entity, the corresponding routing function may be implemented by the entity for AAA.

After the interworking entity obtains a first identity, e.g., IMSI, of the UE from the entity for authentication in 5GC, the entity for AAA may receive an identity response message from the interworking entity. The identity response message may include the first identity, e.g., IMSI, of the UE, which may be converted by the interworking entity from a second identity, e.g., SUPI, of the UE that is in turn de-concealed by an entity for authentication in 5GC associated with the UE from the concealed identity, e.g., SUCI, of the UE.

The identity response message may also be received over the Diameter-based interface, e.g., the SWx′ interface.

Then, the entity for AAA may perform the existing authentication credential retrieval process based on the first identity, e.g. IMSI, of the UE that has been de-concealed from the entity for authentication in 5GC.

In particular, the entity for AAA may transmit a request message for authentication credentials (called a “second request message for authentication credentials” throughout the description) to an entity for authentication in EPC associated with the UE, optionally via the routing entity. The second request message for authentication credentials may at least include the received first identity, e.g., IMSI, of the UE.

Then, the entity for AAA may receive a second response message for authentication credentials from the entity for authentication in EPC, optionally via the routing entity.

The second response message for authentication credentials may include:
an authentication method selected by the entity for authentication in EPC, or requested by the entity for authentication in EPC from the entity for authentication in 5GC, and
an authentication vector generated by the entity for authentication in EPC or requested by the entity for authentication in EPC from the entity for authentication in 5GC.

It may be understood that the retrieval of the authentication credentials, such as the authentication method, the authentication vector of the UE is implemented by the entity for authentication in EPC with the existing authentication credential retrieval approach, which is not a part of the present disclosure, and thus will be simply described later in the method performed by the entity for authentication in EPC for completeness.

FIG. 6B schematically shows an exemplary method 600B performed by a routing entity according to the second exemplary embodiment of the present disclosure. It should be understood that the routing entity may be an SLF/DRA, or any other entity that may be configured to perform the method 600B as described below, including a virtualized entity that may be implemented on cloud.

It should also be understood that the method 600B performed by the routing entity at least partly corresponds to the method 500B performed by the entity for AAA. Thus, some description of the method 600B may refer to that of method 500B as previously described, and thus will be omitted here for simplicity.

In step S601B, the routing entity may receive from the entity for AAA, e.g., 3GPP AAA sever, an identity request message for retrieving a de-concealed identity (also called a “first identity”), e.g., IMSI, of the UE. The identity request message may include the detected concealed identity, e.g., SUCI, of the UE.

Then in step S603B, the routing entity may forward the identity request message to an interworking entity, e.g., AAA-IWF/NSSAAF.

The identity request message may be received and forwarded over a Diameter-based interface, e.g., an SWx′ interface, supporting the concealed identity, e.g., SUCI, of the UE.

That is, the routing entity may assist in routing the identity request message towards the entity for authentication in 5GC via the interworking entity.

After the interworking entity obtains a first identity, e.g., IMSI, of the UE from the entity for authentication in 5GC, the routing entity may receive an identity response message from the interworking entity. The identity response message may include the first identity, e.g., IMSI, of the UE, which may be converted by the interworking entity from a second identity, e.g., SUPI, of the UE that is in turn de-concealed by an entity for authentication in 5GC associated with the UE from the concealed identity, e.g., SUCI, of the UE.

Then, the routing entity may forward the identity response message to the entity for AAA.

The identity response message may be received and forwarded over the Diameter-based interface, e.g., the SWx′ interface, either.

Then, the routing entity may receive a second request message for authentication credentials from the entity for AAA. The second request message for authentication credentials may at least include the received first identity, e.g., IMSI, of the UE.

Then, the routing entity may forward the received second request message for authentication credentials to an entity for authentication in EPC associated with the UE.

Next, the routing entity may receive a second response message for authentication credentials from the entity for authentication in EPC, optionally via the routing entity.

The second response message for authentication credentials may include:
an authentication method selected by the entity for authentication in EPC, or requested by the entity for authentication in EPC from the entity for authentication in 5GC, and
an authentication vector generated by the entity for authentication in EPC or requested by the entity for authentication in EPC from the entity for authentication in 5GC.

Then, the routing entity may forward the received second response message for authentication credentials to the entity for AAA.

It may be understood that the retrieval of the authentication credentials, such as the authentication method, the authentication vector of the UE is implemented by the entity for authentication in EPC with the existing authentication credential retrieval approach, which is not a part of the present disclosure, and thus will be simply described later in the method performed by the entity for authentication in EPC for completeness.

It may be understood that although the method 600B performed by the routing entity is described here separately, it may be performed by the entity for AAA in absence of a separate routing entity.

FIG. 7B schematically shows an exemplary method 700B performed by an interworking entity according to the second exemplary embodiment of the present disclosure. It should be understood that the interworking entity may be an AAA-IWF/NSSAAF, or any other entity that may be configured to perform the method 700B as described below, including a virtualized entity that may be implemented on cloud.

It should also be understood that the method 700B performed by the interworking entity at least partly corresponds to the method 500B performed by the entity for AAA, and optionally, the method 600B performed by the routing entity. Thus, some description of the method 700B may refer to that of method 500B, and optionally, that of method 600B as previously described, and thus will be omitted here for simplicity.

In step S701B, the interworking entity may receive, from an entity for AAA, e.g., 3GPP AAA sever, an identity request message for retrieving a de-concealed identity (also called a “first identity”), e.g., IMSI, of the UE.

As previously described, the identity request message may include a concealed identity, e.g., SUCI, of the UE. The identity request message may be received over a Diameter-based interface, e.g., an SWx′ interface, supporting the concealed identity, e.g., SUCI, of the UE.

As previously described, the identity request message may be received from the entity for AAA via the routing entity.

Then in step S703B, the interworking entity may select an entity for authentication in 5GC associated with the UE based on the received concealed identity of the UE. In an exemplary embodiment, the entity for authentication in 5GC associated with the UE may be selected by the interworking entity based on a routing indicator included in the received concealed identity, e.g., SUCI, of the UE.

Then in step S705B, the interworking entity may transmit a request message for identity de-concealment to the selected entity for authentication in 5GC. In an exemplary embodiment, the request message for identity de-concealment may be a new SBI request message for identity de-concealment that is translated by the interworking entity from the identity request message over the Diameter-based interface, e.g., an SWx′ interface, supporting the concealed identity, e.g., SUCI, of the UE.

The request message for identity de-concealment may include the received concealed identity, e.g., SUCI, of the UE.

Then, the interworking entity may receive a response message for identity de-concealment from the selected entity for authentication in 5GC. The response message for identity de-concealment may include a second identity, e.g., SUPI, of the UE that is de-concealed by the selected entity for authentication in 5GC from the concealed identity, e.g., SUCI, of the UE; convert the received second identity, e.g., SUPI, of the UE to a first identity, e.g., IMSI, of the UE; and transmit an identity response message to the entity for AAA. The identity response message may include the first identity, e.g., IMSI, of the UE.

FIG. 8B schematically shows an exemplary method 800B performed by an entity for authentication in 5GC according to the second exemplary embodiment of the present disclosure. It should be understood that the entity for authentication in 5GC may be a UDM/ARPF/SIDF, or any other entity that may be configured to perform the method 800B as described below, including a virtualized entity that may be implemented on cloud.

It should also be understood that the method 800B performed by the entity for authentication in 5GC at least partly corresponds to the method 700B performed by the interworking entity. Thus, some description of the method 800B may refer to that of method 700B, and thus will be omitted here for simplicity.

In step S801B, the entity for authentication in 5GC may receive a request message for identity de-concealment from an interworking entity, e.g., AAA-IWF/NSSAAF. As previously described, the request message for identity de-concealment may include the received concealed identity, e.g., SUCI, of the UE.

In step S803B, the entity for authentication in 5GC may de-conceal a second identity, e.g., SUPI, of the UE from the received concealed identity, e.g., SUCI, of the UE.

Then in step S805B, the entity for authentication in 5GC may transmit a response message for identity de-concealment to the interworking entity. The response message for identity de-concealment may include the de-concealed second identity, e.g., SUPI, of the UE.

As previously described, the method performed by the entity for authentication in EPC for Non-3GPP access authentication in the second exemplary embodiment is not a part of the present disclosure, and will be described simply here for completeness.

After the entity for AAA receives the first identity, e.g., IMSI, of the UE, it may transmit a second request message for authentication credentials to an entity for authentication in EPC associated with the UE, optionally via the routing entity over a Diameter-based interface supporting the first identity, e.g., IMSI, of the UE. The second request message for authentication credentials may at least include the first identity, e.g., IMSI, of the UE, and optionally, an ANID of the Non-3GPP access network to which the UE is connected.

Thus, the entity for authentication in EPC may receive, from the entity for AAA, the second request message for authentication credentials over a Diameter-based interface supporting the first identity, e.g., IMSI, of the UE. The second request message may at least include the first identity, e.g., IMSI, of the UE, and optionally, the ANID.

If the authentication vector generation function for the UE is deployed in the entity for authentication in EPC, the entity for authentication in EPC may directly provide the authentication credentials, such as the authentication method, the AV, for the UE to the entity for AAA.

Alternatively, if the authentication vector generation function for the UE is deployed in the entity for authentication in 5GC, the entity for authentication in EPC may transmit a further request message for authentication credentials to the entity for authentication in 5GC over a UDICOM NU1 interface, in order to obtain the authentication credentials for the UE from the entity for authentication in 5GC.

Then, the entity for authentication in EPC may transmit a second response message for authentication credentials to the entity for AAA over the Diameter-based interface supporting the first identity, e.g., IMSI, of the UE.

The second response message for authentication credentials may include: an authentication method selected by the entity for authentication in EPC, or requested by the entity for authentication in EPC from the entity for authentication in 5GC, and an authentication vector generated by the entity for authentication in EPC or requested by the entity for authentication in EPC from the entity for authentication in 5GC.

Hereinafter, a Non-3GPP access authentication for a UE according to the second exemplary embodiment of the present disclosure will be described with reference to an exemplary signaling sequence diagram as shown in FIG. 10B, in which the methods of FIGS. 3, 4, 5B, 6B, 7B, and 8B may be applied. Some description of the exemplary signaling sequence diagram as shown in FIG. 10B may refer to that of methods 300, 400, 500B, 600B, 700B, and 800B as previously described, and thus will be omitted here for simplicity.

Similar with the exemplary signaling sequence diagram of FIG. 10A, in the following description on the exemplary signaling sequence diagram of FIG. 10B, a WLAN AP is illustrated as an example of the Non-3GPP access element as previously described, a 3GPP AAA server is illustrated as an example of the entity for AAA, an SLF/DRA (not shown) is illustrated as an example of the routing entity, an AAA-IWF/NSSAAF is illustrated as an example of the interworking entity, a UDM/ARPF/SIDF is illustrated as an example of the entity for authentication in 5GC, and an HSS/AUC is illustrated as an example of the entity for authentication in EPC.

It should be understood that the above exemplary entities are only used here for illustration but without any limitation. Respective entities other than those mentioned here or any combination thereof may cooperate to perform the Non-3GPP access authentication for the UE, as long as the methods 300, 500B, 600B, 700B, and 800B may be implemented respectively.

It should be noted that the description below mainly focuses on signaling related to the methods 300, 400, 500B, 600B, 700B, and 800B, and some other signaling is not described in detail to avoid obscuring the principle of the present disclosure. In FIG. 10B, modification on the signaling related to the methods 300, 400, 500B, 600B, 700B, and 800B is shown in Bold Italics, in which e.g., Signaling S10B_0b, S10B_5˜S10A_7, and S10B_9 are involved. In the exemplary signaling sequence diagram of FIG. 10B, Signaling S10B_0a˜ S10B_5 in FIG. 10B are similar with Signaling S10A_0a˜ S10A_5 in FIG. 10A. The only difference consists in that the UE determines that the UE identity privacy should be used in S10B_Ob, and thus transmits an EAP Response/Identity message to the WLAN AP in S10B_3, with SUCI in NAI, and the 3GPP AAA Server thus detects the SUCI from the NAI in S10B_5. Thus, detailed description on those Signaling S10B_0a˜S10B_5 may refer to that on Signaling S10A_0a˜S10A_5, and will be omitted here for simplicity.

In S10B_6, the 3GPP AAA Server may transmit an IMSI retrieval request with SUCI received from S10B_4 and detected in S10B_5 via a new Diameter-based command over SWx′.

An optional SLF/DRA (not shown) may assist in routing the new Diameter SWx′ request towards a UDM/ARPF/SIDF via the AAA-IWF/NSSAAF.

NOTE: In a case where the NAI received from S10B_4 contains a SUCI protected with Null Scheme, the 3GPP AAA server may retrieve IMSI from the SUCI by itself and skip S10B_6 to S10B_10.

In S10B_7, the AAA-IWF/NSSAAF may discover and select an UDM/ARPF/SIDF e.g. based on the routing identifier of the SUCI. The AAA-IWF/NSSAAF may transmit a SUCI Deconcealment Request using a new Nudm service, e.g. Nudm_SUCIDeconcealment_Get, to the UDM/ARPF/SIDF. In S10B_8, the UDM/ARPF/SIDF may de-conceal the SUPI from the SUCI.

In S10B_9, the UDM/ARPF/SIDF may transmit the SUCI Deconcealment Response to the AAA-IWF/NSSAAF with the SUPI.

In S10B_10, the AAA-IWF/NSSAAF may convert the SUPI into the IMSI, and transmit the IMSI retrieval Response to the 3GPP AAA server over SWx′.

In S10B_11, the 3GPP AAA Server may transmit an AV Request message with the IMSI and optionally, the ANID received in S10B_4. The AV Request message may be routed to the HSS via SWx as currently specified. In the presence of multiple HSS instances in the home network of the UE, an SLF/DRA will assist in routing the SWx request to the HSS associated with the UE.

In scenarios where the home network supports a mixture of 4G only users, 5G users supporting interworking with EPC, and 5G only users, the SLF/DRA may also assist in routing the AV Request messages towards the HSS/AUC (for 4G only users, 5G users supporting interworking with EPC) or towards the UDM/ARPF/SIDF (for 5G only users) via an AAA-IWF realized by the NSSAAF.

In S10B_12, if the HSS/AUC supports the authentication vector generation function for the UE, the HSS/AUC may provide the authentication credentials, such as the authentication method, AV, for the UE to the 3GPP AAA server as currently defined. If the authentication vector generation function for the UE has been moved to the UDM/ARPF/SIDF, the HSS/AUC may requests the authentication credentials from the UDM/ARPF/SIDF using the UDICOM NU1 reference point as currently specified.

In S10B_13, the HSS/AUC may transmit an AV Response message to the 3GPP AAA server over Diameter SWx. The flows continue with S10B_14.

Signaling S10B_14˜S10B_17b in FIG. 10B are identical with Signaling S10A_14˜S10A_17b in FIG. 10A. Therefore, description on those Signaling S10B_14˜S10B_17b may refer to that on Signaling S10A_14˜S10A_17b, and will be omitted for simplicity.

In the third exemplary embodiment, authentication credentials (e.g., an authentication method, an authentication vector etc.) for the UE may be retrieved from an entity for authentication in EPC based on a concealed identity, e.g. SUCI, of the UE.

Hereinafter, methods for Non-3GPP access authentication of the UE performed by an entity for AAA, a routing entity, an interworking entity, and an entity for authentication in 5GC according to the second exemplary embodiment will be described with reference to FIGS. 50, 6C, 8C, and 9B, respectively.

FIG. 5C schematically shows an exemplary method 500C performed by the entity for AAA according to the third exemplary embodiment of the present disclosure. It should be understood that the entity for AAA may be a 3GPP AAA server, or any other entity that may be configured to perform the method 500C as described below, including a virtualized entity that may be implemented on cloud.

In step S501C, the entity for AAA may receive a request message for authentication from a Non-3GPP access element.

The request message for authentication received from the Non-3GPP access network may include an identity of the UE to be authenticated. The identity of the UE may include a concealed identity, e.g., SUCI, of the UE, which depends on the determination result of the UE on that the UE identity privacy should be used for communication with the Non-3GPP access network, and may be contained in NAI carried by the request message for access authentication from the UE to the Non-3GPP access network, and/or the request message for authentication from the Non-3GPP access network to the entity for AAA.

Then in step S503C, the entity for AAA may detect the concealed identity, e.g., SUCI, of the UE from the received request message for authentication.

Then in step S505C, the entity for AAA may transmit a third request message for authentication credentials to an entity for authentication in EPC, e.g., HSS, associated with the UE. The third request message for authentication credentials may at least include the detected concealed identity, e.g., SUCI, of the UE.

In an exemplary embodiment, the entity for AAA may transmit the third request message for authentication credentials to the entity for authentication in EPC via a routing entity, e.g., SLF/DRA. In this case, it is the routing entity that selects the entity for authentication in EPC, which will be described in detail later.

Alternatively in an exemplary embodiment where there is no separate routing entity, the entity for AAA may select, in an entity for network repository (e.g., NRF), the entity for authentication in EPC based on the detected concealed identity, e.g., SUCI, of the UE.

The entity for authentication in EPC may be selected in the entity for network repository based on a routing indicator included in the detected concealed identity of the UE.

Then in step S505C, the entity for AAA may transmit the third request message for authentication credentials to the selected entity for authentication in EPC.

The third request message for authentication credentials may be transmitted over a Diameter-based interface, e.g., an SWx′ interface, supporting the concealed identity, e.g., SUCI, of the UE.

Then, the entity for AAA may receive a third response message for authentication credentials from the entity for authentication in EPC. The third response message for authentication credentials may be received over the Diameter-based interface, e.g., the SWx′ interface, either.

The third response message for authentication credentials may include:
an authentication method selected by the entity for authentication in EPC, or requested by the entity for authentication in EPC from an entity for authentication in 5GC, e.g., UDM, associated with the UE,
an authentication vector generated by the entity for authentication in EPC or requested by the entity for authentication in EPC from the entity for authentication in 5GC, and
a first identity, e.g., IMSI, of the UE obtained from the concealed identity, e.g., SUCI, of the UE.

FIG. 6C schematically shows an exemplary method 600C performed by a routing entity according to the third exemplary embodiment of the present disclosure. It should be understood that the routing entity may be an SLF/DRA, or any other entity that may be configured to perform the method 600A as described below, including a virtualized entity that may be implemented on cloud.

It should also be understood that the method 600C performed by the routing entity at least partly corresponds to the method 500C performed by the entity for AAA. Thus, some description of the method 600C may refer to that of method 500C as previously described, and thus will be omitted here for simplicity.

In step S601C, the routing entity may receive a third request message for authentication credentials from an entity for AAA, e.g., a 3GPP AAA server. The third request message for authentication credentials may at least include the detected concealed identity, e.g., SUCI, of a UE to be authenticated.

Then in step S603C, the routing entity may select, in an entity for network repository (e.g., NRF), an entity for authentication in EPC (e.g., HSS) based on the detected concealed identity, e.g., SUCI, of the UE.

The entity for authentication in EPC may be selected in the entity for network repository based on a routing indicator included in the detected concealed identity of the UE.

Then in step S605C, the routing entity may forward the third request message for authentication credentials to the selected entity for authentication in EPC.

The third request message for authentication credentials may be received and forwarded over a Diameter-based interface, e.g., an SWx′ interface, supporting the concealed identity, e.g., SUCI, of the UE.

Then, the routing entity may receive a third response message for authentication credentials from the entity for authentication in EPC, and forward it to the entity for AAA.

The third response message for authentication credentials may include:
an authentication method selected by the entity for authentication in EPC, or requested by the entity for authentication in EPC from an entity for authentication in 5GC, e.g., UDM, associated with the UE, an authentication vector generated by the entity for authentication in EPC or requested by the entity for authentication in EPC from the entity for authentication in 5GC, and
a first identity, e.g., IMSI, of the UE obtained from the concealed identity, e.g., SUCI, of the UE.

The third response message for authentication credentials may be received and forwarded over the Diameter-based interface, e.g., the SWx′ interface, either.

It may be understood that although the method 600C performed by the routing entity is described here separately, it may be performed by the entity for AAA in absence of a separate routing entity.

FIG. 9C schematically shows an exemplary method 900C performed by an entity for authentication in EPC according to the third exemplary embodiment of the present disclosure. It should be understood that the entity for authentication in EPC may be an HSS/AUC, or any other entity that may be configured to perform the method 900C as described below, including a virtualized entity that may be implemented on cloud.

It should also be understood that the method 900C performed by the entity for authentication in EPC at least partly corresponds to the method 5C performed by the entity for AAA. Thus, some description of the method 900C may refer to that of method 500C, and thus will be omitted here for simplicity.

As previously described, the routing entity or the entity for AAA may select, in an entity for network repository (e.g., NRF), an entity for authentication in EPC based on the routing indicator included in the detected concealed identity, e.g., SUCI, of the UE.

Accordingly, the entity for authentication in EPC should register, in the entity for network repository, routing indicator(s) that the entity for authentication in EPC supports, so that the routing entity or the entity for AAA can select, from the entity for network repository, the entity for authentication in EPC based on the routing indicator included in the detected concealed identity, e.g., SUCI, of the UE.

In step S901C, the entity for authentication in EPC may receive a third request message for authentication credentials from an entity for AAA, e.g., a 3GPP AAA server. The third request message for authentication credentials may at least include a concealed identity, e.g., SUCI, of a UE to be authenticated.

The third request message for authentication credentials may be received over a Diameter-based interface, e.g., an SWx′ interface, supporting the concealed identity, e.g., SUCI, of the UE.

Then, the entity for authentication in EPC may transmit a sixth request message for authentication credentials to an entity for authentication in 5GC, e.g., UDM, associated with the UE. The sixth request message for authentication credentials may at least include an indication of a requesting node being the entity for AAA, and the concealed identity, e.g., SUCI, of the UE.

The sixth request message for authentication credentials may be transmitted over e.g., the UDICOM NU1 reference point.

Accordingly, the entity for authentication in EPC may receive a sixth response message for authentication credentials from the entity for authentication in 5GC over e.g., the UDICOM NU1 reference point. The sixth response message for authentication credentials may at least include a first identity (e.g., IMSI) or second identity (e.g., SUPI) of the UE that may be obtained from the concealed identity (e.g., SUCI) of the UE.

In an exemplary embodiment, the entity for authentication in EPC may select an authentication method for the UE at least based on the indication of the requesting node being the entity for AAA and the first identity, e.g., IMSI, of the UE; and generate an authentication vector for the UE at least based on the first identity of the UE.

In another exemplary embodiment, the entity for authentication in EPC may retrieve the corresponding authentication credentials from the entity for authentication in 5GC. In this case, the sixth response message for authentication credentials may further include authentication credentials for the UE, in addition to the first identity (e.g., IMSI) or second identity (e.g., SUPI) of the UE. The authentication credentials may include: an authentication method for the UE selected by the entity for authentication in 5GC; and an authentication vector for the UE generated by the entity for authentication in 5GC.

Then, the entity for authentication in EPC may transmit a third response message for authentication credentials to the entity for AAA. The third response message for authentication credentials may include the authentication method, the authentication vector, and the first identity, e.g., IMSI, of the UE that may be obtained from the second identity, e.g., SUPI, of the UE.

The third response message for authentication credentials may be transmitted over the Diameter-based interface, e.g., the SWx′ interface, either.

FIG. 8C schematically shows an exemplary method 800C performed by an entity for authentication in 5GC according to the third exemplary embodiment of the present disclosure. It should be understood that the entity for authentication in 5GC may be a UDM/ARPF/SIDF, or any other entity that may be configured to perform the method 800C as described below, including a virtualized entity that may be implemented on cloud.

It should also be understood that the method 800C performed by the entity for authentication in 5GC at least partly corresponds to the method 900C performed by the entity for authentication in EPC. Thus, some description of the method 800C may refer to that of method 900C as previously described, and thus will be omitted here for simplicity.

In step S801C, the entity for authentication in 5GC may receive a sixth request message for authentication credentials from the entity for authentication in EPC, e.g., HSS. The sixth request message for authentication credentials may at least include an indication of a requesting node being the entity for AAA, and the concealed identity, e.g., SUCI, of the UE, and optionally, an access network identity, e.g., ANID, related to a Non-3GPP access element to which the UE is connected.

The sixth request message for authentication credentials may be received over e.g., the UDICOM NU1 reference point.

Then in step S803C, the entity for authentication in 5GC may obtain a first identity (e.g., IMSI) or a second identity (e.g., SUPI) of the UE from the concealed identity (e.g., SUCI) of the UE.

Then in step S805C, the entity for authentication in 5GC may transmit a sixth response message for authentication credentials to the entity for authentication in EPC over e.g., the UDICOM NU1 reference point. The sixth response message for authentication credentials may at least include the obtained first identity (e.g., IMSI) or second identity (e.g., SUPI) of the UE.

In an exemplary embodiment, the entity for authentication in 5GC may de-conceal a second identity (e.g., SUPI) of the UE from the concealed identity (e.g., SUCI) of the UE. Optionally, the entity for authentication in 5GC may convert the second identity (e.g., SUPI) of the UE to the first identity (e.g., IMSI) of the UE.

In an exemplary embodiment, the entity for authentication in 5GC may obtain authentication credentials, such as an authentication method, an authentication vector, for the UE. In particular, the entity for authentication in 5GC may select an authentication method for the UE at least based on the indication of the requesting node being the entity for AAA and the second identity (e.g., SUPI) of the UE; and generate an authentication vector for the UE at least based on the second identity (e.g., SUPI) of the UE.

In this case, the entity for authentication in 5GC may provide the authentication credentials and the identity of the UE (e.g., IMSI) to the entity for authentication in EPC. Accordingly, the sixth response message for authentication credentials transmitted to the entity for authentication in EPC may include: the authentication credentials for the UE and the identity of the UE (e.g., IMSI).

In an exemplary embodiment, the entity for authentication in 5GC may only transmit the first or second identity of the UE in the sixth response message for authentication credentials to the entity for authentication in EPC. And the corresponding authentication credentials may be provided by the entity for authentication in EPC, which has been described previously in the method 900C.

Hereinafter, a Non-3GPP access authentication for a UE according to the third exemplary embodiment of the present disclosure will be described with reference to an exemplary signaling sequence diagram as shown in FIG. 10C, in which the methods of FIGS. 3, 4, 50, 60, 8C, and 9B may be applied. Some description of the exemplary signaling sequence diagram as shown in FIG. 10C may refer to that of methods 300, 400, 500C, 600C, 800C, and 900C as previously described, and thus will be omitted here for simplicity.

Similar with the exemplary signaling sequence diagrams of FIGS. 10A and 10B, in the following description on the exemplary signaling sequence diagram of FIG. 10C, a WLAN AP is illustrated as an example of the Non-3GPP access element as previously described, a 3GPP AAA server is illustrated as an example of the entity for AAA, an SLF/DRA (not shown) is illustrated as an example of the routing entity, an AAA-IWF/NSSAAF is illustrated as an example of the interworking entity, a UDM/ARPF/SIDF is illustrated as an example of the entity for authentication in 5GC, and an HSS/AUC is illustrated as an example of the entity for authentication in EPC.

It should be understood that the above exemplary entities are only used here for illustration but without any limitation. Respective entities other than those mentioned here or any combination thereof may cooperate to perform the Non-3GPP access authentication for the UE, as long as the methods 300, 500C, 600C, 800C, and 900C may be implemented respectively.

It should be noted that the description below mainly focuses on signaling related to the methods 300, 400, 500C, 600C, 800C, and 900C, and some other signaling is not described in detail to avoid obscuring the principle of the present disclosure. In FIG. 10C, modification on the signaling related to the methods 300, 400, 500C, 600C, 800C, and 900C is shown in Bold Italics, in which e.g., Signaling S10C_Ob, and S10C_5˜S10C_8 are involved.

In the exemplary signaling sequence diagram of FIG. 10C, Signaling S10C_0a˜S10C_5 in FIG. 10C are identical with Signaling S10B_0a˜ S10B_5 in FIG. 10B. Thus, detailed description on those Signaling S10C_0a˜ S10C_5 may refer to that on Signaling S10B_0a˜S10B_5, and will be omitted here for simplicity.

In S10C_6, the 3GPP AAA Server may transmit an AV Request message with SUCI received from S10C_4 and detected in S10C_5 via a new Diameter-based command over SWx′. The AV Request message may optionally include the ANID received in S10C_4.

The AV Request message may be routed to the HSS/AUC via (updated) SWx′.

In the presence of multiple HSS/AUC instances in the home network of the UE, an optional SLF/DRA (not shown) may assist in routing the SWx′ request to the HSS where the UE is defined, i.e., associated with the UE.

The SLF/DRA may discover and select from NRF an HSS e.g. based on the routing indicator included in the SUCI. For this purpose, the HSS need to register its supported routing indicator(s) in NRF in advance.

In S10C_7, the HSS may request the authentication credentials and IMSI from the UDM/ARPF/SIDF using a new service operation of UDICOM NU1 reference point, with the SUCI, an indication of a requesting node being the 3GPP AAA server, and optionally, the ANID.

The UDM/ARPF/SIDF may de-conceal the SUPI from the SUCI and generates the AKA AV of EAP-AKA′ and sends back to the HSS.

In S10C_8, the HSS may transmit the AV Response message to the 3GPP AAA server over Diameter SWx/SWx′. The flows continue with In S10C_14.

Signaling S10C_14˜S10C_17b in FIG. 10C are identical with Signaling S10A_14˜S10A_17b in FIG. 10A. Therefore, description on those Signaling S10C_14˜S10C_17b may refer to that on Signaling S10A_14˜S10A_17b, and will be omitted for simplicity.

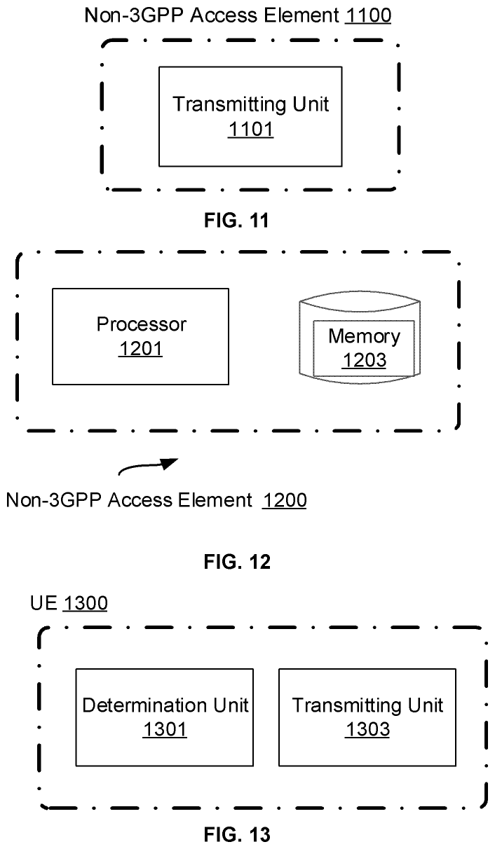

Hereinafter, an exemplary structure of a Non-3GPP access element according to any of the first to third exemplary embodiments of the present disclosure will be described with reference to FIG. 11. FIG. 11 schematically shows an exemplary structural block diagram of the Non-3GPP access element 1100 according to any of the first to third exemplary embodiments of the present disclosure. The Non-3GPP access element 1100 in FIG. 11 may perform the method 300 with reference to FIG. 3. Accordingly, some detailed description on the Non-3GPP access element 1100 may refer to the corresponding description of the method 300 in FIG. 1 and the signaling sequence diagrams in FIGS. 10A˜10C, and thus will be omitted here for simplicity.

As shown in FIG. 11, the Non-3GPP access element 1100 may include at least a transmitting unit 1101.

The transmitting unit 1101 may be configured to transmit a list of networks, via each of which the Non-3GPP access element may at least have support for UE identity privacy.

In an exemplary embodiment, the Non-3GPP access element, via each network in the list of networks, may further have support for connectivity with an entity for AAA for access authentication.

In an exemplary embodiment, the Non-3GPP access element 1100 may include a receiving unit (not shown), which may be configured to receive, from a UE, a request message for access authentication including an identity of the UE. Then, the transmitting unit 1101 may be configured to transmit, to the entity for AAA, a request message for authentication including the identity of the UE.

In an exemplary embodiment, the identity of the UE may include a concealed identity of the UE or a first identity of the UE.

In an exemplary embodiment, the concealed identity of the UE may include a SUCI of the UE, and the first identity of the UE may include an IMSI of the UE. In an exemplary embodiment, the request message for authentication may further include an access network identity of the Non-3GPP access network. In an exemplary embodiment, the list of networks may include a list of PLMNs, and the entity for AAA may include a 3GPP AAA server.

Hereinafter, another exemplary structure of a Non-3GPP access element 1200 according to any of the first to third exemplary embodiments of the present disclosure will be described with reference to FIG. 12. FIG. 12 schematically shows an exemplary structural block diagram of a Non-3GPP access element 1200 according to any of the first to third exemplary embodiments of the present disclosure. The Non-3GPP access element 1200 in FIG. 12 may perform the method 300 as described previously with reference to FIG. 3. Accordingly, some detailed description on the Non-3GPP access element 1200 may refer to the corresponding description of the method 300 in FIG. 3 and the signaling sequence diagrams in FIGS. 10A˜10C, and thus will be omitted here for simplicity.

As shown in FIG. 12, the Non-3GPP access element 1200 includes at least one processor 1201 and at least one memory 1203. The at least one processor 1201 includes e.g., any suitable CPU (Central Processing Unit), microcontroller, DSP (Digital Signal Processor), etc., capable of executing computer program instructions. The at least one memory 1203 may be any combination of a RAM (Random Access Memory) and a ROM (Read Only Memory). The at least one processor memory 1203 may also include persistent storage, which, for example, can be any single one or combination of magnetic memory, optical memory, or solid state memory or even remotely mounted memory.

The at least one memory 1203 stores instructions executable by the at least one processor 1201. The instructions, when loaded from the at least one memory 1203 and executed on the at least one processor 1201, may cause the Non-3GPP access element 1200 to perform the actions, e.g., of the procedures as described earlier in conjunction with FIG. 3, and thus will be omitted here for simplicity.

Hereinafter, an exemplary structure of a UE according to any of the first to third exemplary embodiments of the present disclosure will be described with reference to FIG. 13. FIG. 13 schematically shows an exemplary structural block diagram of the UE 1300 according to any of the first to third exemplary embodiments of the present disclosure. The UE 1300 in FIG. 13 may perform the method 400 as described previously with reference to FIG. 4. Accordingly, some detailed description on the UE 1300 may refer to the corresponding description of the method 400 in FIG. 4 and the signaling sequence diagrams in FIGS. 10A˜10C, and thus will be omitted here for simplicity.

As shown in FIG. 13, the UE 1300 may include at least a determination unit 1301 and a transmitting unit 1303.

The determination unit 1301 may be configured to determine whether UE identity privacy should be used for communication with a Non-3GPP access network for the UE. The transmitting unit 1303 may be configured to transmit, to a Non-3GPP access element in the Non-3GPP access network, a request message for access authentication that may include an identity of the UE depending on a result of the determination.

In an exemplary embodiment, it is determined whether the UE identity privacy should be used for communication with the Non-3GPP access network for the UE based on at least one of:
configuration of the UE;
information about the Non-3GPP access element in the Non-3GPP access network; or
information about a home network of the UE.

In an exemplary embodiment, the UE 1300 may further include a configuration unit (not shown), which may be configured to receive or preconfigure the configuration of the UE. The configuration of the UE may include information indicating whether the UE has support for the UE identity privacy.

In an exemplary embodiment, the method may further include a receiving unit (not shown), which may be configured to receive, from the Non-3GPP access element, the information about the Non-3GPP access element indicating whether the Non-3GPP access element has support for the UE identity privacy, wherein the information about the Non-3GPP access element may include a list of networks, via each of which the Non-3GPP access element may at least have the support for the UE identity privacy.

In an exemplary embodiment, the Non-3GPP access element, via each network in the list of networks, may further have support for connectivity with an entity for AAA for access authentication.

In an exemplary embodiment, the receiving unit may further be configured to receive, from the home network, the information about the home network indicating whether the home network has support for the UE identity privacy.

In an exemplary embodiment, the information about the home network indicating whether the home network may have support for the UE identity privacy may be carried in a UPU procedure or an SoR procedure.

In an exemplary embodiment, the support for the UE identity privacy may include support for the UE identity privacy for Non-3GPP access authentication.

In an exemplary embodiment, the request message for access authentication may include a concealed identity of the UE, if it is determined that the UE identity privacy should be used, and the request message for access authentication may include a first identity of the UE should be used, if it is determined that the UE identity privacy should not be used.

In an exemplary embodiment, the concealed identity of the UE may include a SUCI of the UE, and the first identity of the UE may include an IMSI of the UE.

In an exemplary embodiment, the communication with the Non-3GPP access network may include NSWO from the Non-3GPP access network for the UE.

In an exemplary embodiment, the list of networks may include a list of PLMNs, and the entity for AAA may include a 3GPP AAA server.

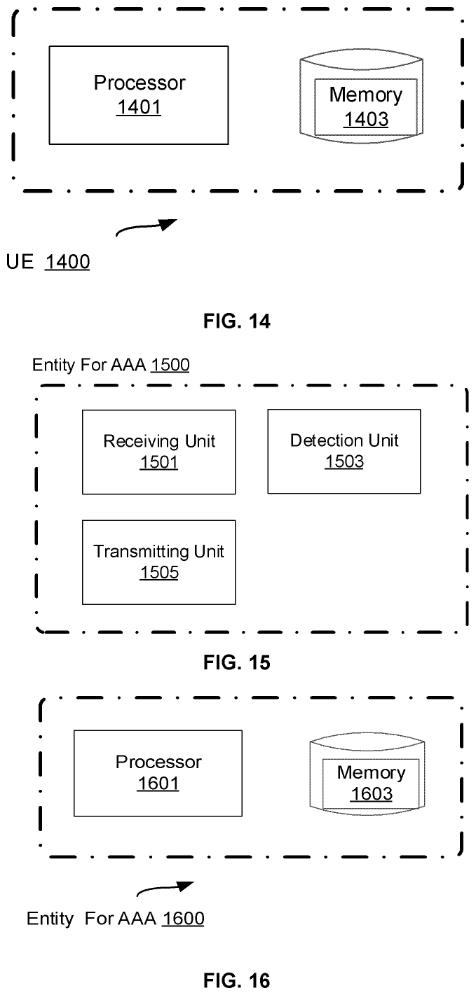

Hereinafter, another exemplary structure of a UE according to another exemplary embodiment of the present disclosure will be described with reference to FIG. 14. FIG. 14 schematically shows an exemplary structural block diagram of a UE 1400 according to an exemplary embodiment of the present disclosure. The UE 1400 in FIG. 14 may perform the method 400 as described previously with reference to FIG. 4. Accordingly, some detailed description on the UE 1400 may refer to the corresponding description of the method 400 in FIG. 4 and the signaling sequence diagrams in FIGS. 10A˜10C, and thus will be omitted here for simplicity.

As shown in FIG. 14, the UE 1400 includes at least one processor 1401 and at least one memory 1403. The at least one processor 1401 includes e.g., any suitable CPU (Central Processing Unit), microcontroller, DSP (Digital Signal Processor), etc., capable of executing computer program instructions. The at least one memory 1403 may be any combination of a RAM (Random Access Memory) and a ROM (Read Only Memory). The at least one processor memory 1403 may also include persistent storage, which, for example, can be any single one or combination of magnetic memory, optical memory, or solid state memory or even remotely mounted memory.

The at least one memory 1403 stores instructions executable by the at least one processor 1401. The instructions, when loaded from the at least one memory 1403 and executed on the at least one processor 1401, may cause the UE 1400 to perform the actions, e.g., of the procedures as described earlier in conjunction with FIG. 4, and thus will be omitted here for simplicity.

Hereinafter, an exemplary structure of an entity for AAA according to any of the first to third exemplary embodiments of the present disclosure will be described with reference to FIG. 15. FIG. 15 schematically shows an exemplary structural block diagram of the entity for AAA 1500 according to any of the first to third exemplary embodiments of the present disclosure. The entity for AAA 1500 in FIG. 15 may perform the method 500A according to the first exemplary embodiments as described previously with reference to FIG. 5A, the method 500B according to the second exemplary embodiments as described previously with reference to FIG. 5B, and the method 500C according to the third exemplary embodiments as described previously with reference to FIG. 5C, respectively. Accordingly, some detailed description on the entity for AAA 1500 may refer to the corresponding description of the respective methods 500A˜500C in the respective FIGS. 5A˜5C and the respective signaling sequence diagrams in FIGS. 10A˜10C, and thus will be omitted here for simplicity.

As shown in FIG. 15, the entity for AAA 1500 may include at least a receiving unit 1501, a detection unit 1503, and a transmitting unit 1505.

In the first exemplary embodiment having been described with reference to FIGS. 5A and 10A, the receiving unit 1501 may be configured to receive, from a Non-3GPP access element, a request message for authentication including an identity of a UE to be authenticated, wherein the identity of the UE may include a concealed identity of the UE or a first identity of the UE. The detection unit 1503 may be configured to detect the identity of the UE from the received request message for authentication. The transmitting unit 1505 may be configured to transmit, to an interworking entity, a first request message for authentication credentials, which may at least include the detected identity of the UE.

In an exemplary embodiment, the first request message for authentication credentials may be transmitted to the interworking entity via a routing entity. In an exemplary embodiment, in a case where the identity of the UE in the received request message for authentication may include the concealed identity of the UE, the concealed identity of the UE may be detected; and the first request message for authentication credentials may include the detected concealed identity of the UE, and may be transmitted to the interworking entity over a Diameter-based interface supporting the concealed identity of the UE. In an exemplary embodiment, in a case where the identity of the UE in the received request message for authentication may include the first identity of the UE or the concealed identity of the UE that is protected with a Null Scheme, the first identity of the UE may be detected; and the first request message for authentication credentials may include the first identity of the UE, and may be transmitted to the interworking entity over a Diameter-based interface supporting the first identity of the UE.

In an exemplary embodiment, the receiving unit 1501 may be further configured to receive, from the interworking entity, a first response message for authentication credentials, which may include: an authentication method selected by an entity for authentication in 5GC associated with the UE or requested by the entity for authentication in 5GC from an entity for authentication in EPC associated with the UE, an authentication vector generated by the entity for authentication in 5GC or requested by the entity for authentication in 5GC from the entity for authentication in EPC, and a first identity of the UE obtained from the detected identity of the UE.

In an exemplary embodiment, the concealed identity of the UE may include a SUCI of the UE, and the first identity of the UE may include an IMSI of the UE.

In an exemplary embodiment, the request message for authentication may further include an access network identity related to the Non-3GPP access element, and the first request message for authentication credentials may further include the access network identity related to the Non-3GPP access element.

In an exemplary embodiment, the entity for AAA may include a 3GPP AAA server, the routing entity may include an SLF/DRA, and the entity for network repository may include an NRF.

In the second exemplary embodiment having been described with reference to FIGS. 5B and 10B, the receiving unit 1501 may be configured to receive, from a Non-3GPP access element, a request message for authentication including a concealed identity of a UE to be authenticated. The detection unit 1503 may be configured to detect the concealed identity of the UE from the received request message for authentication. The transmitting unit 1505 may be configured to transmit, to an interworking entity, an identity request message including the detected concealed identity of the UE.

In an exemplary embodiment, the identity request message may be transmitted to the interworking entity via a routing entity.

In an exemplary embodiment, the concealed identity of the UE may include a SUCI of the UE.

In an exemplary embodiment, the receiving unit 1501 may be further configured to receive, from the interworking entity, an identity response message including a first identity of the UE, which is converted by the interworking entity from a second identity of the UE that is in turn de-concealed by an entity for authentication in 5GC associated with the UE from the concealed identity of the UE. And the transmitting unit 1505 may be further configured to forward the identity response message to the entity for AAA.

In an exemplary embodiment, the identity request message may be transmitted over a Diameter-based interface supporting the concealed identity of the UE, and the identity response message may be received over the Diameter-based interface.

In an exemplary embodiment, the transmitting unit 1505 may be further configured to transmit, to an entity for authentication in EPC associated with the UE, a second request message for authentication credentials, which may at least include the received first identity of the UE. And the receiving unit 1501 may be further configured to receive, from the entity for authentication in EPC, a second response message for authentication credentials, which may include:
an authentication method selected by the entity for authentication in EPC, or requested by the entity for authentication in EPC from the entity for authentication in 5GC, and an authentication vector generated by the entity for authentication in EPC or requested by the entity for authentication in EPC from the entity for authentication in 5GC.

In an exemplary embodiment, the first identity of the UE may include an IMSI of the UE, and the second identity of the UE may include a SUPI of the UE.

In an exemplary embodiment, the entity for AAA may include a 3GPP AAA server, the routing entity may include an SLF/DRA, and the entity for network repository may include an NRF.

In the third exemplary embodiment having been described with reference to FIGS. 5C and 10C, the receiving unit 1501 may be configured to receive, from a Non-3GPP access element, a request message for authentication including a concealed identity of a UE to be authenticated. The detection unit 1503 may be configured to detect the concealed identity of the UE from the received request message for authentication. The transmitting unit 1505 may be configured to transmit, to an entity for authentication in EPC associated with the UE, a third request message for authentication credentials, which may at least include the detected concealed identity of the UE.

In an exemplary embodiment, the entity for AAA 1500 may further include a selection unit (not shown), which may be configured to select, in an entity for network repository, the entity for authentication in EPC based on the detected concealed identity of the UE. The transmitting unit 1505 may be further configured to transmit the third request message for authentication credentials to the selected entity for authentication in EPC.

In an exemplary embodiment, the entity for authentication in EPC may be selected in the entity for network repository based on a routing indicator included in the detected concealed identity of the UE.

In an exemplary embodiment, the third request message for authentication credentials may be transmitted to the interworking entity via a routing entity.

In an exemplary embodiment, the concealed identity of the UE may include a SUCI of the UE.

In an exemplary embodiment, the receiving unit 1501 may be further configured to receive, from the entity for authentication in EPC, a third response message for authentication credentials, which may include: an authentication method selected by the entity for authentication in EPC, or requested by the entity for authentication in EPC from an entity for authentication in 5GC associated with the UE, an authentication vector generated by the entity for authentication in EPC or requested by the entity for authentication in EPC from the entity for authentication in 5GC, and a first identity of the UE obtained from the concealed identity of the UE.

In an exemplary embodiment, the third request message for authentication credentials may be transmitted over a Diameter-based interface supporting the concealed identity of the UE, and the third response message for authentication credentials may be received over the Diameter-based interface. In an exemplary embodiment, the first identity of the UE may include an IMSI of the UE.

In an exemplary embodiment, the entity for AAA may include a 3GPP AAA server, the routing entity may include an SLF/DRA, and the entity for network repository may include an NRF.

Hereinafter, another exemplary structure of an entity for AAA according to any of the first to third exemplary embodiments of the present disclosure will be described with reference to FIG. 16. FIG. 16 schematically shows an exemplary structural block diagram of an entity for AAA 1600 according to any of the first to third exemplary embodiments of the present disclosure. The entity for AAA 1600 in FIG. 16 may perform the method 500A according to the first exemplary embodiments as described previously with reference to FIG. 5A, the method 500B according to the second exemplary embodiments as described previously with reference to FIG. 5B, and the method 500C according to the third exemplary embodiments as described previously with reference to FIG. 5C, respectively. Accordingly, some detailed description on the entity for AAA 1600 may refer to the corresponding description of the respective methods 500A˜500C in the respective FIGS. 5A˜5C and the respective signaling sequence diagrams in FIGS. 10A˜10C, and thus will be omitted here for simplicity.

As shown in FIG. 16, the entity for AAA 1600 includes at least one processor 1601 and at least one memory 1603. The at least one processor 1601 includes e.g., any suitable CPU (Central Processing Unit), microcontroller, DSP (Digital Signal Processor), etc., capable of executing computer program instructions. The at least one memory 1603 may be any combination of a RAM (Random Access Memory) and a ROM (Read Only Memory). The at least one processor memory 1603 may also include persistent storage, which, for example, can be any single one or combination of magnetic memory, optical memory, or solid state memory or even remotely mounted memory.

The at least one memory 1603 stores instructions executable by the at least one processor 1601. The instructions, when loaded from the at least one memory 1603 and executed on the at least one processor 1601, may cause the entity for AAA 1600 to perform the actions, e.g., of the respective procedures as described earlier in conjunction with FIGS. 5A˜5C, and thus will be omitted here for simplicity.

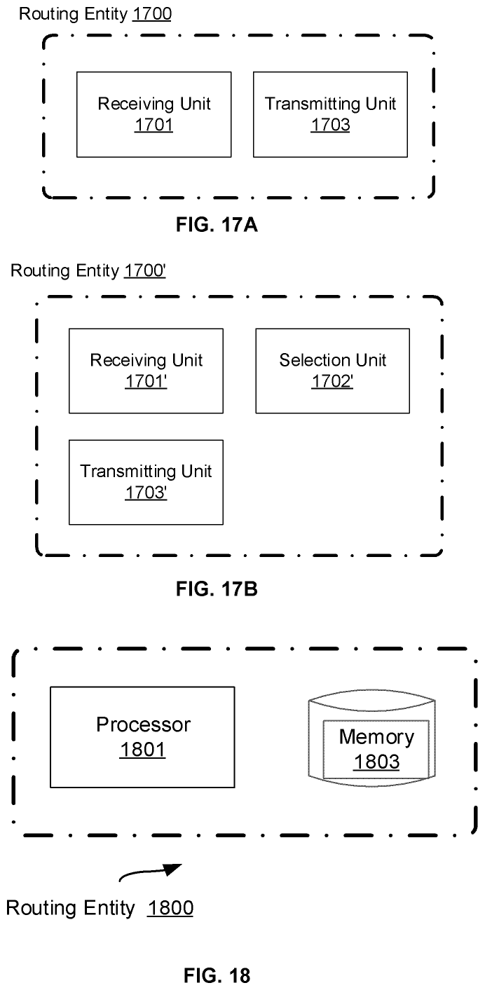

Hereinafter, an exemplary structure of a routing entity according to any of the first to second exemplary embodiments of the present disclosure will be described with reference to FIG. 17A. FIG. 17A schematically shows an exemplary structural block diagram of the routing entity 1700 according to any of the first to second exemplary embodiments of the present disclosure. The routing entity 1700 in FIG. 17A may perform the method 600A according to the first exemplary embodiments as described previously with reference to FIG. 6A, and the method 600B according to the second exemplary embodiments as described previously with reference to FIG. 6B, respectively. Accordingly, some detailed description on the routing entity 1700 may refer to the corresponding description of the respective methods 600A and 600B in the respective FIGS. 6A and 6B and the respective signaling sequence diagrams in FIGS. 10A and 10B, and thus will be omitted here for simplicity.

As shown in FIG. 17A, the routing entity 1700 may include at least a receiving unit 1701 and a transmitting unit 1703.

In the first exemplary embodiment having been described with reference to FIGS. 6A and 10A, the receiving unit 1701 may be configured to receive, from an entity for AAA, a first request message for authentication credentials, which may at least include an identity of a UE to be authenticated, wherein the identity of the UE may include a concealed identity of the UE or a first identity of the UE. The transmitting unit 1703 may be configured to forward the first request message for authentication credentials to an interworking entity.

In an exemplary embodiment, in a case where the identity of the UE may include the concealed identity of the UE, the first request message for authentication credentials may be received and forwarded over a Diameter-based interface supporting the concealed identity of the UE.

In an exemplary embodiment, in a case where the identity of the UE may include the first identity of the UE, the first request message for authentication credentials may be received and forwarded over a Diameter-based interface supporting the first identity of the UE.

In an exemplary embodiment, the receiving unit 1701 may be further configured to receive, from the interworking entity, a first response message for authentication credentials, which may include: an authentication method selected by an entity for authentication in 5GC associated with the UE or requested by the entity for authentication in 5GC from an entity for authentication in EPC associated with the UE, an authentication vector generated by the entity for authentication in 5GC or requested by the entity for authentication in 5GC from the entity for authentication in EPC, and a first identity of the UE obtained from the identity of the UE. The transmitting unit 1703 may be further configured to forward the first response message for authentication credentials to the entity for AAA.

In an exemplary embodiment, the concealed identity of the UE may include a SUCI of the UE, and the first identity of the UE may include an IMSI of the UE.

In an exemplary embodiment, the first request message for authentication credentials may further include an access network identity related to a Non-3GPP access element to which the UE is connected.

In an exemplary embodiment, the routing entity may include an SLF/DRA, the entity for AAA may include a 3GPP AAA server, and the entity for network repository may include an NRF.

In the second exemplary embodiment having been described with reference to FIGS. 6B and 10B, the receiving unit 1701 may be configured to receive, from an entity for AAA, an identity request message including a concealed identity of a UE to be authenticated. The transmitting unit 1703 may be configured to forward the identity request message to an interworking entity.

In an exemplary embodiment, the concealed identity of the UE may include a SUCI of the UE.

In an exemplary embodiment, the receiving unit 1701 may be further configured to receive, from the interworking entity, an identity response message including a first identity of the UE, which may be converted by the interworking entity from a second identity of the UE that may be in turn de-concealed by an entity for authentication in 5GC associated with the UE from the concealed identity of the UE.

In an exemplary embodiment, the identity request message may be received and forwarded over a Diameter-based interface supporting the concealed identity of the UE, and the identity response message of the UE may be received and forwarded over the Diameter-based interface.

In an exemplary embodiment, the receiving unit 1701 may be further configured to receive, from the entity for AAA, a second request message for authentication credentials for the UE, which may at least include the received first identity of the UE. The transmitting unit 1703 may be further configured to forward, to an entity for authentication in EPC associated with the UE, the received second request message for authentication credentials.

In an exemplary embodiment, the first identity of the UE may include an IMSI of the UE, and the second identity of the UE may include a SUPI of the UE.

In an exemplary embodiment, the receiving unit 1701 may be further configured to receive, from the entity for authentication in EPC, a second response message for authentication credentials, which may include: an authentication method selected by the entity for authentication in EPC or requested by the entity for authentication in EPC from the entity for authentication in 5GC, and an authentication vector generated by the entity for authentication in EPC or requested by the entity for authentication in EPC from an entity for authentication in 5GC. The transmitting unit 1703 may be further configured to forward, to the entity for AAA, the received second response message for authentication credentials.

In an exemplary embodiment, the routing entity may include an SLF/DRA, the entity for AAA may include a 3GPP AAA server, and the entity for network repository may include an NRF.

Hereinafter, an exemplary structure of a routing entity according to the third exemplary embodiments of the present disclosure will be described with reference to FIG. 17B. FIG. 17B schematically shows an exemplary structural block diagram of the routing entity 1700′ according to the third exemplary embodiments of the present disclosure. The routing entity 1700′ in FIG. 17B may perform the method 600C according to the third exemplary embodiments as described previously with reference to FIG. 6C. Accordingly, some detailed description on the routing entity 1700′ may refer to the corresponding description of the method 600C in FIG. 6C and the signaling sequence diagram in FIG. 10C, and thus will be omitted here for simplicity.

As shown in FIG. 17B, the routing entity 1700′ may include at least a receiving unit 1701′, a selection unit 1702′ and a transmitting unit 1703′.

In the third exemplary embodiment having been described with reference to FIGS. 6C and 10C, the receiving unit 1701′ may be configured to receive, from an entity for AAA, a third request message for authentication credentials, which may at least include a concealed identity of a UE to be authenticated. The selection unit 1702′ may be configured to select, in an entity for network repository, an entity for authentication in EPC based on the received concealed identity of the UE. THE transmitting unit 1703′ may be configured to forward the third request message for authentication credentials to the selected entity for authentication in EPC.

In an exemplary embodiment, the entity for authentication in EPC may be selected in the entity for network repository based on a routing indicator included in the concealed identity of the UE.

In an exemplary embodiment, the receiving unit 1701′ may be further configured to receive, from the entity for authentication in EPC, a third response message for authentication credentials, which may include: an authentication method selected by the entity for authentication in EPC, or requested by the entity for authentication in EPC from an entity for authentication in 5GC associated with the UE, an authentication vector generated by the entity for authentication in EPC or requested by the entity for authentication in EPC from the entity for authentication in 5GC, and a first identity of the UE obtained from the concealed identity of the UE. The transmitting unit 1703′ may be further configured to forward, to the entity for AAA, the received second response message for authentication credentials.

In an exemplary embodiment, the third request message for authentication credentials may be received and forwarded over a Diameter-based interface supporting the concealed identity of the UE, and the third response message for authentication credentials may be received and forwarded over the Diameter-based interface.

In an exemplary embodiment, the concealed identity of the UE may include a SUCI of the UE, and the first identity of the UE may include an IMSI of the UE.

In an exemplary embodiment, the routing entity may include an SLF/DRA, the entity for AAA may include a 3GPP AAA server, and the entity for network repository may include an NRF.

Hereinafter, another exemplary structure of a routing entity according to any of the first to third exemplary embodiments of the present disclosure will be described with reference to FIG. 18. FIG. 18 schematically shows an exemplary structural block diagram of a routing entity 1800 according to any of the first to third exemplary embodiments of the present disclosure. The routing entity 1800 in FIG. 18 may perform the method 600A according to the first exemplary embodiment as described previously with reference to FIG. 6A, the method 600B according to the second exemplary embodiment as described previously with reference to FIG. 6B, and the method 600C according to the third exemplary embodiment as described previously with reference to FIG. 6C, respectively. Accordingly, some detailed description on the routing entity 1800 may refer to the corresponding description of the respective methods 600A˜600C in the respective FIGS. 6A˜6C and the respective signaling sequence diagrams in FIGS. 10A˜10C, and thus will be omitted here for simplicity.

As shown in FIG. 18, the routing entity 1800 includes at least one processor 1801 and at least one memory 1803. The at least one processor 1801 includes e.g., any suitable CPU (Central Processing Unit), microcontroller, DSP (Digital Signal Processor), etc., capable of executing computer program instructions. The at least one memory 1803 may be any combination of a RAM (Random Access Memory) and a ROM (Read Only Memory). The at least one processor memory 1803 may also include persistent storage, which, for example, can be any single one or combination of magnetic memory, optical memory, or solid state memory or even remotely mounted memory.

The at least one memory 1803 stores instructions executable by the at least one processor 1801. The instructions, when loaded from the at least one memory 1803 and executed on the at least one processor 1801, may cause the routing entity 1800 to perform the actions, e.g., of the respective procedures as described earlier in conjunction with FIGS. 6A˜6C, and thus will be omitted here for simplicity.

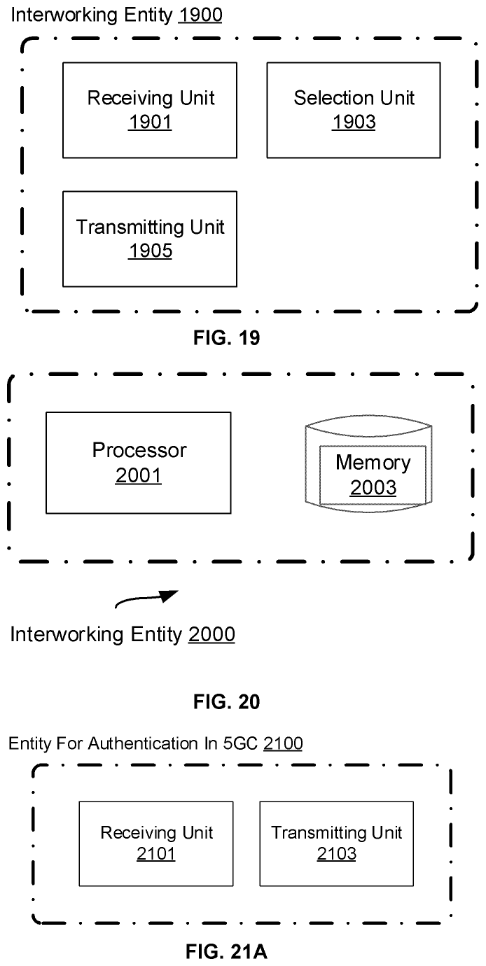

Hereinafter, an exemplary structure of an interworking entity according to any of the first to second exemplary embodiments of the present disclosure will be described with reference to FIG. 19. FIG. 19 schematically shows an exemplary structural block diagram of the interworking entity 1900 according to any of the first to second exemplary embodiments of the present disclosure. The interworking entity 1900 in FIG. 19 may perform the method 700A according to the first exemplary embodiment as described previously with reference to FIG. 7A, and the method 700B according to the second exemplary embodiment as described previously with reference to FIG. 7B, respectively. Accordingly, some detailed description on the routing entity 1700 may refer to the corresponding description of the respective methods 700A and 700B in the respective FIGS. 7A and 7B and the respective signaling sequence diagrams in FIGS. 10A and 10B, and thus will be omitted here for simplicity.

As shown in FIG. 19, the interworking entity 1900 may include at least a receiving unit 1901, a selection unit 1903, and a transmitting unit 1905.

In the first exemplary embodiment having been described with reference to FIGS. 7A and 10A, the receiving unit 1901 may be configured to receive, from an entity for AAA, a first request message for authentication credentials, which may at least include an identity of a UE to be authenticated, wherein the received identity of the UE may include a concealed identity of the UE or a first identity of the UE. The selection unit 1903 may be configured to select an entity for authentication in 5GC associated with the UE based on the received identity of the UE. The transmitting unit 1905 may be configured to transmit, to the selected entity for authentication in 5GC, a fourth request message for authentication credentials.

In an exemplary embodiment, the first request message for authentication credentials may be received from the entity for AAA via a routing entity.

In an exemplary embodiment, the receiving unit 1901 may be further configured to receive, from the selected entity for authentication in 5GC, a fourth response message for authentication credentials, wherein the fourth response message for authentication credentials may at least include: an authentication method selected by the selected entity for authentication in 5GC or requested by the selected entity for authentication in 5GC from an entity for authentication in EPC associated with the UE, and an authentication vector generated by the selected entity for authentication in 5GC or requested by the selected entity for authentication in 5GC from the entity for authentication in EPC.

In an exemplary embodiment, in a case where the received identity of the UE includes the concealed identity of the UE, the first request message for authentication credentials may be received over a Diameter-based interface supporting the concealed identity of the UE, the entity for authentication in 5GC may be selected based on a routing indicator included in the received concealed identity of the UE, the fourth request message for authentication credentials may at least include an indication of a requesting node being the entity for AAA and the concealed identity of the UE, and the fourth response message for authentication credentials may further include a second identity of the UE that is de-concealed by the entity for authentication in 5GC from the concealed identity of the UE.

In an exemplary embodiment, in a case where the received identity of the UE includes the first identity of the UE, the first request message for authentication credentials may be received over a Diameter-based interface supporting the first identity of the UE, the entity for authentication in 5GC may be selected based on the first identity of the UE, the fourth request message for authentication credentials may at least include an indication of a requesting node being the entity for AAA and a second identity of the UE that is converted by the interworking entity from the first identity of the UE, and the fourth response message for authentication credentials may further include the second identity of the UE.

In an exemplary embodiment, the fourth request message for authentication credentials may further include an access network identity related to a Non-3GPP access element to which the UE is connected.

In an exemplary embodiment, the transmitting unit 1905 may be further configured to transmit, to the entity for AAA, a first response message for authentication credentials, which may include: the authentication method, the authentication vector, and a first identity of the UE obtained from the received identity of the UE.

In an exemplary embodiment, the concealed identity of the UE may include a SUCI of the UE, and the first identity of the UE may include an IMSI of the UE.

In an exemplary embodiment, the routing entity may include an SLF/DRA, and the entity for AAA may include a 3GPP AAA server.

In the second exemplary embodiment having been described with reference to FIGS. 7B and 10B, the receiving unit 1901 may be configured to receive, from an entity for AAA, an identity request message including a concealed identity of a UE to be authenticated. The selection unit 1903 may be configured to select an entity for authentication in 5GC associated with the UE based on the received concealed identity of the UE. The transmitting unit 1905 may be configured to transmit, to the selected entity for authentication in 5GC, a request message for identity de-concealment, which may include the received concealed identity of the UE.

In an exemplary embodiment, the identity request message may be received from the entity for AAA via a routing entity.

In an exemplary embodiment, the identity request message may be received over a Diameter-based interface supporting the concealed identity of the UE, and the entity for authentication in 5GC associated with the UE may be selected based on a routing indicator included in the received concealed identity of the UE.

In an exemplary embodiment, the concealed identity of the UE may include a SUCI of the UE.

In an exemplary embodiment, the receiving unit 1901 may be further configured to receive, from the selected entity for authentication in 5GC, a response message for identity de-concealment, which may include a second identity of the UE that is de-concealed by the selected entity for authentication in 5GC from the concealed identity of the UE. The interworking entity 1900 may further include a conversion unit (not shown), which may be configured to convert the received second identity of the UE to a first identity of the UE. The transmitting unit 1905 may be further configured to transmit, to the entity for AAA, an identity response message including the first identity of the UE.

In an exemplary embodiment, the first identity of the UE may include an IMSI of the UE, and the second identity of the UE may include a SUPI of the UE.

In an exemplary embodiment, the routing entity may include an SLF/DRA, and the entity for AAA may include a 3GPP AAA server.

Hereinafter, another exemplary structure of an interworking entity according to any of the first to second exemplary embodiments of the present disclosure will be described with reference to FIG. 20. FIG. 20 schematically shows an exemplary structural block diagram of an interworking entity 2000 according to any of the first to second exemplary embodiments of the present disclosure. The interworking entity 2000 in FIG. 20 may perform the method 700A according to the first exemplary embodiment as described previously with reference to FIG. 7A, and the method 700B according to the second exemplary embodiment as described previously with reference to FIG. 7B, respectively.

Accordingly, some detailed description on the interworking entity 2000 may refer to the corresponding description of the respective methods 700A and 700B in the respective FIGS. 7A and 7B and the respective signaling sequence diagrams in FIGS. 10A and 10B, and thus will be omitted here for simplicity.

As shown in FIG. 20, the interworking entity 2000 includes at least one processor 2001 and at least one memory 2003. The at least one processor 2001 includes e.g., any suitable CPU (Central Processing Unit), microcontroller, DSP (Digital Signal Processor), etc., capable of executing computer program instructions. The at least one memory 2003 may be any combination of a RAM (Random Access Memory) and a ROM (Read Only Memory). The at least one processor memory 2003 may also include persistent storage, which, for example, can be any single one or combination of magnetic memory, optical memory, or solid state memory or even remotely mounted memory.

The at least one memory 2003 stores instructions executable by the at least one processor 2001. The instructions, when loaded from the at least one memory 2003 and executed on the at least one processor 2001, may cause the interworking entity 2000 to perform the actions, e.g., of the respective procedures as described earlier in conjunction with FIGS. 7A and 7B, and thus will be omitted here for simplicity.

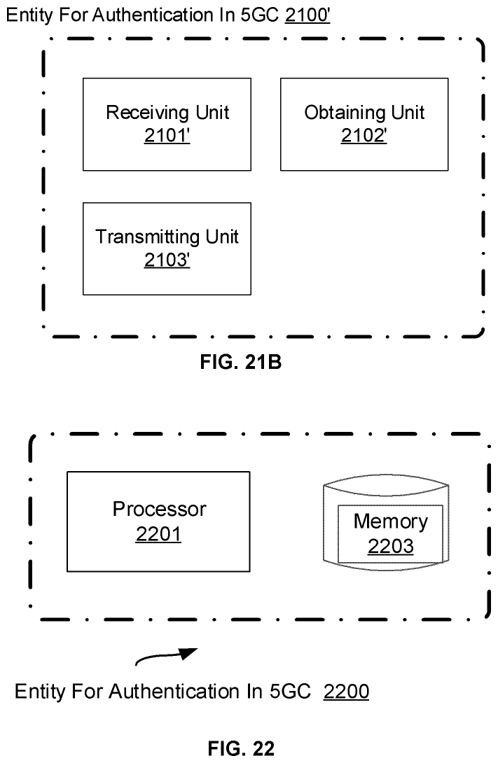

Hereinafter, an exemplary structure of an entity for authentication in 5GC according to the first exemplary embodiment of the present disclosure will be described with reference to FIG. 21A. FIG. 21A schematically shows an exemplary structural block diagram of the entity 2100 for authentication in 5GC according to the first exemplary embodiment of the present disclosure. The entity 2100 for authentication in 5GC in FIG. 21A may perform the method 800A as described previously with reference to FIG. 8A. Accordingly, some detailed description on the entity 2100 for authentication in 5GC may refer to the corresponding description of the method 800A in the respective FIG. 7A and the signaling sequence diagram in FIG. 10A, and thus will be omitted here for simplicity.

As shown in FIG. 21A, the entity 2100 for authentication in 5GC may include at least a receiving unit 2101 and a transmitting unit 2103.

The receiving unit 2101 may be configured to receive, from an interworking entity, a fourth request message for authentication credentials for a UE to be authenticated, which may at least include an indication of a requesting node being an entity for AAA, and an identity of the UE. The transmitting unit 2103 may be configured to transmit a fourth response message for authentication credentials to the interworking entity.

In an exemplary embodiment, the fourth request message for authentication credentials may further include an access network identity related to a Non-3GPP access element to which the UE is connected.

In an exemplary embodiment, the received identity of the UE may include a concealed identity of the UE. The entity 2100 for authentication in 5GC may further include an obtaining unit (not shown), which may be configured to de-conceal a second identity of the UE from the received concealed identity of the UE.

In an exemplary embodiment, the received identity of the UE may include a second identity of the UE.

In an exemplary embodiment, the obtaining unit may be configured to select an authentication method for the UE at least based on the indication of the requesting node being the entity for AAA and the second identity of the UE, and generate an authentication vector for the UE at least based on the second identity of the UE.

In an exemplary embodiment, the transmitting unit 2103 may be further configured to transmit, to the entity for authentication in EPC, a fifth request message for authentication credentials, which may at least include: the indication of the requesting node being the entity for AAA, and the identity of the UE. The receiving unit 2103 may be further configured to receive, from the entity for authentication in EPC, a fifth response message for authentication credentials, which may include an authentication method for the UE and an authentication vector for the UE.

In an exemplary embodiment, the concealed identity of the UE may include a SUCI of the UE, and the second identity of the UE may include a SUPI of the UE.

In an exemplary embodiment, the fifth request message for authentication credentials may further include an access network identity related to a Non-3GPP access element to which the UE is connected.

In an exemplary embodiment, the entity for AAA may include a 3GPP AAA server.

Hereinafter, an exemplary structure of an entity for authentication in 5GC according to any of the second and third exemplary embodiments of the present disclosure will be described with reference to FIG. 21B. FIG. 21B schematically shows an exemplary structural block diagram of the entity 2100′ for authentication in 5GC according to any of the second and third exemplary embodiments of the present disclosure. The entity 2100′ for authentication in 5GC in FIG. 21B may perform the method 800B as described previously with reference to FIG. 8B, and the method 800C as described previously with reference to FIG. 8C, respectively. Accordingly, some detailed description on the entity 2100′ for authentication in 5GC may refer to the corresponding description of the methods 800B and 800C in the respective FIGS. 7B and 7C and the respective signaling sequence diagrams in FIGS. 10B and 10C, and thus will be omitted here for simplicity.

As shown in FIG. 21B, the entity 2100′ for authentication in 5GC may include at least a receiving unit 2101, an obtaining unit 2102′ and a transmitting unit 2103′.

In the second exemplary embodiment having been described with reference to FIGS. 8B and 10B, the receiving unit 2101′ may be configured to receive, from an interworking entity, a request message for identity de-concealment, which may include a concealed identity of a UE to be authenticated. The obtaining unit 2102′ may be configured to de-conceal a second identity of the UE from the received concealed identity of the UE. The transmitting unit 2103′ may be configured to transmit, to the interworking entity, a response message for identity de-concealment, which may include the second identity of the UE.

In an exemplary embodiment, the concealed identity of the UE may include a SUCI of the UE, and the second identity of the UE may include a SUPI of the UE.

In the third exemplary embodiment having been described with reference to FIGS. 8C and 10C, the receiving unit 2101′ may be configured to The receiving unit 2101′ may be configured to receive, from an entity for authentication in EPC associated with a UE to be authenticated, a sixth request message for authentication credentials, which may at least include an indication of a requesting node being an entity for AAA, and a concealed identity of the UE. The obtaining unit 2102′ may be configured to obtain a first identity or a second identity of the UE from the concealed identity of the UE. The transmitting unit 2103′ may be configured to transmit, to the entity for authentication in EPC, a sixth response message for authentication credentials, which may at least include the obtained first identity or second identity of the UE.

In an exemplary embodiment, the obtaining unit 2102′ may be further configured to de-conceal a second identity of the UE from the concealed identity of the UE, and convert the second identity of the UE to the first identity of the UE.

In an exemplary embodiment, the obtaining unit 2102′ may be further configured to de-conceal the second identity of the UE from the concealed identity of the UE.

In an exemplary embodiment, the obtaining unit 2102′ may be further configured to obtain authentication credentials for the UE, and wherein the sixth response message for authentication credentials may further include the authentication credentials for the UE.

In an exemplary embodiment, the authentication credentials for the UE may include: an authentication method for the UE and an authentication vector for the UE. The obtaining unit 2102′ may be further configured to select an authentication method for the UE at least based on the indication of the requesting node being the entity for AAA and the second identity of the UE, and generate an authentication vector for the UE at least based on the second identity of the UE.

In an exemplary embodiment, the concealed identity of the UE may include a SUCI of the UE, the first identity of the UE may include an IMSI of the UE, and the second identity of the UE may include a SUPI of the UE.

In an exemplary embodiment, the sixth request message for authentication credentials may further include an access network identity related to a Non-3GPP access element to which the UE is connected.

In an exemplary embodiment, the entity for AAA may include a 3GPP AAA server.

Hereinafter, another exemplary structure of an entity for authentication in 5GC according to any of the first to third exemplary embodiments of the present disclosure will be described with reference to FIG. 22. FIG. 22 schematically shows an exemplary structural block diagram of an entity 2200 for authentication in 5GC according to any of the first to third exemplary embodiments of the present disclosure. The entity 2200 for authentication in 5GC may perform the method 800A according to the first exemplary embodiment as described previously with reference to FIG. 8A, the method 800B according to the second exemplary embodiment as described previously with reference to FIG. 8B, and the method 800C according to the third exemplary embodiment as described previously with reference to FIG. 8C, respectively. Accordingly, some detailed description on the entity 2200 for authentication in 5GC may refer to the corresponding description of the respective methods 800A˜800C in the respective FIGS. 8A˜8C and the respective signaling sequence diagrams in FIGS. 10A˜10C, and thus will be omitted here for simplicity.

As shown in FIG. 22, the entity 2200 for authentication in 5GC includes at least one processor 2201 and at least one memory 2203. The at least one processor 2201 includes e.g., any suitable CPU (Central Processing Unit), microcontroller, DSP (Digital Signal Processor), etc., capable of executing computer program instructions. The at least one memory 2203 may be any combination of a RAM (Random Access Memory) and a ROM (Read Only Memory). The at least one processor memory 2203 may also include persistent storage, which, for example, can be any single one or combination of magnetic memory, optical memory, or solid state memory or even remotely mounted memory.

The at least one memory 2203 stores instructions executable by the at least one processor 2201. The instructions, when loaded from the at least one memory 2203 and executed on the at least one processor 2201, may cause the entity 2200 for authentication in 5GC to perform the actions, e.g., of the respective procedures as described earlier in conjunction with FIGS. 8A˜8C, and thus will be omitted here for simplicity.

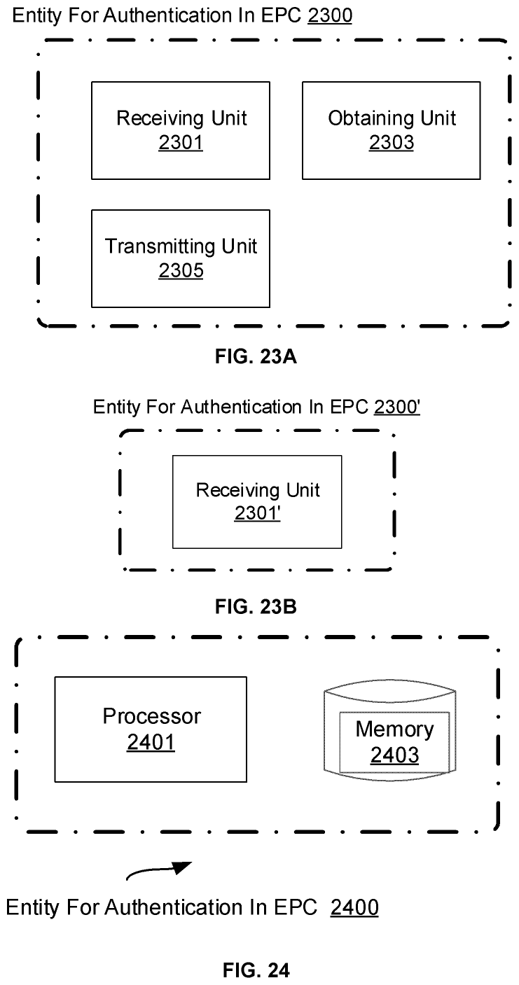

Hereinafter, an exemplary structure of an entity for authentication in EPC according to the first exemplary embodiment of the present disclosure will be described with reference to FIG. 23A. FIG. 23A schematically shows an exemplary structural block diagram of the entity 2300 for authentication in EPC according to the first exemplary embodiment of the present disclosure. The entity 2300 for authentication in EPC in FIG. 23A may perform the method 900A as described previously with reference to FIG. 9A. Accordingly, some detailed description on the entity 2300 for authentication in EPC may refer to the corresponding description of the method 900A in the respective FIG. 9A and the signaling sequence diagram in FIG. 10A, and thus will be omitted here for simplicity.

As shown in FIG. 23A, the entity 2300 for authentication in EPC may include at least a receiving unit 2301, an obtaining unit 2303, and a transmitting unit 2305.

The receiving unit 2301 may be configured to receive, from an entity for authentication in 5GC associated with a UE to be authenticated, a fifth request message for authentication credentials, which may at least include: an indication of a requesting node being an entity for AAA, and a first identity of the UE. The obtaining unit 2303 may be configured to obtain authentication credentials for the UE. The transmitting unit 2305 may be configured to transmit, to the entity for authentication in 5GC, a fifth response message for authentication credentials, which may include the obtained authentication credentials for the UE.

In an exemplary embodiment, the authentication credentials for the UE may include: an authentication method for the UE and an authentication vector for the UE. The obtaining unit 2303 may be further configured to select an authentication method for the UE at least based on the indication of the requesting node being the entity for AAA and the first identity of the UE, and generate an authentication vector for the UE at least based on the first identity of the UE.

In an exemplary embodiment, the first identity of the UE may include an IMSI of the UE.

In an exemplary embodiment, the fifth request message for authentication credentials may further include an access network identity related to a Non-3GPP access element to which the UE is connected.

Hereinafter, an exemplary structure of an entity for authentication in EPC according to the third exemplary embodiment of the present disclosure will be described with reference to FIG. 23B. FIG. 23B schematically shows an exemplary structural block diagram of the entity 2300′ for authentication in EPC according to the third exemplary embodiment of the present disclosure. The entity 2300′ for authentication in EPC in FIG. 23B may perform the method 900C as described previously with reference to FIG. 9B. Accordingly, some detailed description on the entity 2300′ for authentication in EPC may refer to the corresponding description of the method 900C in the respective FIG. 9B and the signaling sequence diagram in FIG. 10C, and thus will be omitted here for simplicity.

As shown in FIG. 23C, the entity 2300′ for authentication in EPC may include at least a receiving unit 2301′.

The receiving unit 2301′ may be configured to receiving, from an entity for AAA, a third request message for authentication credentials, which may at least include a concealed identity of a UE to be authenticated.

In an exemplary embodiment, the entity 2300′ for authentication in EPC may further include a transmitting unit (not shown), which may be configured to transmit, to an entity for authentication in 5GC associated with the UE, a sixth request message for authentication credentials, which may at least include an indication of a requesting node being the entity for AAA, and the concealed identity of the UE. The receiving unit 2301′ may be further configured to receive, from the entity for authentication in 5GC, a sixth response message for authentication credentials, which may at least include a first identity or second identity of the UE that may be obtained from the concealed identity of the UE.

In an exemplary embodiment, the sixth response message for authentication credentials may further include authentication credentials for the UE, which may include: an authentication method for the UE selected by the entity for authentication in 5GC; and an authentication vector for the UE generated by the entity for authentication in 5GC.

In an exemplary embodiment, the entity 2300′ for authentication in EPC may further include an obtaining unit (not shown), which may be configured to select an authentication method for the UE at least based on the indication of the requesting node being the entity for AAA and the first identity of the UE, and generate an authentication vector for the UE at least based on the first identity of the UE.

In an exemplary embodiment, the transmitting unit may be further configured to: transmit, to the entity for AAA, a third response message for authentication credentials, which may include: the authentication method, the authentication vector, and a first identity of the UE obtained from the second identity of the UE.

In an exemplary embodiment, the third request message for authentication credentials may be received over a Diameter-based interface supporting the concealed identity of the UE, and the third response message for authentication credentials may be transmitted over the Diameter-based interface.

In an exemplary embodiment, the entity 2300′ for authentication in EPC may further include a registration unit (not shown), which may be configured to register, in an entity for network repository, a routing indicator that the entity for authentication in EPC supports.

In an exemplary embodiment, the concealed identity of the UE may include a SUCI of the UE, the first identity of the UE may include an IMSI of the UE, and the second identity of the UE may include a SUPI of the UE.

In an exemplary embodiment, the entity for AAA may include a 3GPP AAA server.

Hereinafter, another exemplary structure of an entity for authentication in EPC according to any of the first to third exemplary embodiments of the present disclosure will be described with reference to FIG. 24. FIG. 24 schematically shows an exemplary structural block diagram of an entity 2400 for authentication in EPC according to any of the first and third exemplary embodiments of the present disclosure. The entity 2400 for authentication in EPC may perform the method 900A according to the first exemplary embodiment as described previously with reference to FIG. 9A, and the method 900C according to the third exemplary embodiment as described previously with reference to FIG. 9B, respectively. Accordingly, some detailed description on the entity 2400 for authentication in EPC may refer to the corresponding description of the respective methods 900A and 900C in the respective FIGS. 9A and 9C and the respective signaling sequence diagrams in FIGS. 10A and 10C, and thus will be omitted here for simplicity.

As shown in FIG. 24, the entity 2400 for authentication in EPC includes at least one processor 2401 and at least one memory 2403. The at least one processor 2401 includes e.g., any suitable CPU (Central Processing Unit), microcontroller, DSP (Digital Signal Processor), etc., capable of executing computer program instructions. The at least one memory 2403 may be any combination of a RAM (Random Access Memory) and a ROM (Read Only Memory). The at least one processor memory 2403 may also include persistent storage, which, for example, can be any single one or combination of magnetic memory, optical memory, or solid state memory or even remotely mounted memory.

The at least one memory 2403 stores instructions executable by the at least one processor 2401. The instructions, when loaded from the at least one memory 2403 and executed on the at least one processor 2401, may cause the entity 2400 for authentication in EPC to perform the actions, e.g., of the respective procedures as described earlier in conjunction with FIGS. 9A and 9C, and thus will be omitted here for simplicity.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

Example embodiments of the techniques and apparatus described herein include, but are not limited to, the following enumerated examples:

### Group A Embodiments

A-1. A method (500C) performed by an entity for Authentication, Authorization and Accounting ‘AAA’, comprising:
   receiving (S501C), from a Non-3rd Generation Partnership Project ‘Non-3GPP’ access element, a request message for authentication comprising a concealed identity of a User Equipment ‘UE’ to be authenticated;
   detecting (S503C) the concealed identity of the UE from the received request message for authentication; and
   transmitting (S505C), to an entity for authentication in Evolved Packet Core ‘EPC’ associated with the UE, a third request message for authentication credentials, which at least comprises the detected concealed identity of the UE.
A-2. The method (500C) of Embodiment A-1, further comprising: selecting, in an entity for network repository, the entity for authentication in EPC based on the detected concealed identity of the UE, and
   said transmitting the third request message for authentication credentials comprises: transmitting the third request message for authentication credentials to the selected entity for authentication in EPC.
A-3. The method (500C) of Embodiment A-2, wherein the entity for authentication in EPC is selected in the entity for network repository based on a routing indicator comprised in the detected concealed identity of the UE.
A-4. The method (500C) of any of Embodiments A-1 to A-3, wherein the third request message for authentication credentials is transmitted to the interworking entity via a routing entity.
A-5. The method (500C) of any of Embodiments A-1 to A-4, wherein the concealed identity of the UE comprises a Subscription Concealed Identifier ‘SUCI’ of the UE.
A-6. The method (500C) of any of Embodiments A-1 to A-5, further comprising:
   receiving, from the entity for authentication in EPC, a third response message for authentication credentials, which comprises:
   an authentication method selected by the entity for authentication in EPC, or requested by the entity for authentication in EPC from an entity for authentication in 5GC associated with the UE,
   an authentication vector generated by the entity for authentication in EPC or requested by the entity for authentication in EPC from the entity for authentication in 5GC, and
   a first identity of the UE obtained from the concealed identity of the UE.
A-7. The method (500C) of Embodiment A-6, wherein
   the third request message for authentication credentials is transmitted over a Diameter-based interface supporting the concealed identity of the UE, and
   the third response message for authentication credentials is received over the Diameter-based interface.
A-8. The method (500C) of any of Embodiments A-6 to A-7, wherein
   the first identity of the UE comprises an International Mobile Subscriber Identification ‘IMSI’ of the UE.
A-9. The method (500C) of any of Embodiments A-1 to A-8, wherein
   the entity for AAA comprises a 3GPP AAA server,
   the routing entity comprises a Subscription Locator Function ‘SLF’/Diameter Routing Agent ‘DRA’, and
   the entity for network repository comprises a Network Repository Function ‘NRF’.
A-10. An entity for Authentication, Authorization and Accounting ‘AAA’ (1600), comprising:
   at least one processor (1601), and
   at least one memory (1603), storing instructions which, when executed on the at least one processor (1601), cause the entity for AAA (1600) to perform the method according to at least one of Embodiments A-1 to A-9.
A-11. A computer readable storage medium having computer program instructions stored thereon, the computer program instructions, when executed by at least one processor, causing the at least one processor to perform the method according to at least one of Embodiments A-1 to A-9.

### Group B Embodiments

B-1. A method (600C) performed by a routing entity, comprising:
   receiving (S601C), from an entity for Authentication, Authorization and Accounting ‘AAA’, a third request message for authentication credentials, which at least comprises a concealed identity of a User Equipment ‘UE’ to be authenticated;
   selecting (S603C), in an entity for network repository, an entity for authentication in Evolved Packet Core ‘EPC’ based on the received concealed identity of the UE; and
   forwarding (S605C) the third request message for authentication credentials to the selected entity for authentication in EPC.
B-2. The method (600C) of Embodiment B-1, wherein the entity for authentication in EPC is selected in the entity for network repository based on a routing indicator comprised in the concealed identity of the UE.
B-3. The method (600C) of Embodiment B-1 or B-2, further comprising:
   receiving, from the entity for authentication in EPC, a third response message for authentication credentials, which comprises:
   an authentication method selected by the entity for authentication in EPC, or requested by the entity for authentication in EPC from an entity for authentication in 5GC associated with the UE,
   an authentication vector generated by the entity for authentication in EPC or requested by the entity for authentication in EPC from the entity for authentication in 5GC, and
   a first identity of the UE obtained from the concealed identity of the UE; and
   forwarding, to the entity for AAA, the received second response message for authentication credentials.
B-4. The method (600C) of Embodiment B-3, wherein
   the third request message for authentication credentials is received and forwarded over a Diameter-based interface supporting the concealed identity of the UE, and
   the third response message for authentication credentials is received and forwarded over the Diameter-based interface.
B-5. The method (600C) of any of Embodiments B-1 to B-4, wherein
   the concealed identity of the UE comprises a Subscription Concealed Identifier ‘SUCI’ of the UE, and
   the first identity of the UE comprises an International Mobile Subscriber Identification ‘IMSI’ of the UE.
B-6. The method (600C) of any of Embodiments B-1 to B-6, wherein
   the routing entity comprises a Subscription Locator Function ‘SLF’/Diameter Routing Agent ‘DRA’,
   the entity for AAA comprises a 3GPP AAA server, and
   the entity for network repository comprises a Network Repository Function ‘NRF’.
B-7. A routing entity (1800), comprising:
   at least one processor (1801), and
   at least one memory (1803), storing instructions which, when executed on the at least one processor (1801), cause the routing entity (1800) to perform the method according to at least one of Embodiments B-1 to B-6.
B-8. A computer readable storage medium having computer program instructions stored thereon, the computer program instructions, when executed by at least one processor, causing the at least one processor to perform the method according to at least one of Embodiments B-1 to B-6.

### Group C Embodiments

C-1. A method (800C) performed by an entity for authentication in 5G Core ‘5GC’, comprising:
   receiving (S801C), from an entity for authentication in Evolved Packet Core ‘EPC’ associated with a User Equipment ‘UE’ to be authenticated, a sixth request message for authentication credentials, which at least comprises an indication of a requesting node being an entity for Authentication, Authorization and Accounting ‘AAA’, and a concealed identity of the UE;
   obtaining (S803C) a first identity or a second identity of the UE from the concealed identity of the UE; and
   transmitting (S805C), to the entity for authentication in EPC, a sixth response message for authentication credentials, which at least comprises the obtained first identity or second identity of the UE.
C-2. The method (800C) of Embodiment C-1, wherein said obtaining the first identity of the UE comprises:
   de-concealing a second identity of the UE from the concealed identity of the UE; and
   converting the second identity of the UE to the first identity of the UE.
C-3. The method of Embodiment C-1, wherein said obtaining the second identity of the UE comprises:
   de-concealing the second identity of the UE from the concealed identity of the UE.
C-4. The method (800C) of any of Embodiments C-1 to C-3, further comprising: obtaining authentication credentials for the UE, and
   wherein the sixth response message for authentication credentials further comprises the authentication credentials for the UE.
C-5. The method (800C) of Embodiment C-4, wherein the authentication credentials for the UE comprises: an authentication method for the UE and an authentication vector for the UE, and
   said obtaining the authentication credentials for the UE comprises:
   selecting an authentication method for the UE at least based on the indication of the requesting node being the entity for AAA and the second identity of the UE; and
   generating an authentication vector for the UE at least based on the second identity of the UE.
C-6. The method (800C) of any of Embodiments C-1 to C-5, wherein
   the concealed identity of the UE comprises a Subscription Concealed Identifier ‘SUCI’ of the UE,
   the first identity of the UE comprises an International Mobile Subscriber Identification ‘IMSI’ of the UE, and
   the second identity of the UE comprises a Subscription Permanent Identifier ‘SUPI’ of the UE.
C-7. The method (800C) of any of Embodiments C-1 to C-6, wherein the sixth request message for authentication credentials further comprises an access network identity related to a Non-3GPP access element to which the UE is connected.
C-8. The method (800C) of any of Embodiments C-1 to C-7, wherein
   the entity for AAA comprises a 3GPP AAA server.
C-9. An entity for authentication in 5G Core ‘5GC’ (2200), comprising:
   at least one processor (2201), and
   at least one memory (2203), storing instructions which, when executed on the at least one processor (2201), cause the entity for authentication in 5GC (2200) to perform the method according to at least one of Embodiments C-1 to C-8.
C-10. A computer readable storage medium having computer program instructions stored thereon, the computer program instructions, when executed by at least one processor, causing the at least one processor to perform the method according to at least one of Embodiments C-1 to C-8.

### Group D Embodiments

D-1. A method (900C) performed by an entity for authentication in Evolved Packet Core ‘EPC’, comprising:

receiving (S901C), from an entity for Authentication, Authorization and Accounting ‘AAA’, a third request message for authentication credentials, which at least comprises a concealed identity of a User Equipment ‘UE’ to be authenticated.
D-2. The method (900C) of Embodiment D-1, further comprising:
   transmitting, to an entity for authentication in 5G Core ‘5GC’ associated with the UE, a sixth request message for authentication credentials, which at least comprises an indication of a requesting node being the entity for AAA, and the concealed identity of the UE; and
   receiving, from the entity for authentication in 5GC, a sixth response message for authentication credentials, which at least comprises a first identity or second identity of the UE that is obtained from the concealed identity of the UE.
D-3. The method (900C) of Embodiment D-2, wherein the sixth response message for authentication credentials further comprises authentication credentials for the UE, which comprises:
   an authentication method for the UE selected by the entity for authentication in 5GC; and
   an authentication vector for the UE generated by the entity for authentication in 5GC.
D-4. The method (900C) of Embodiment D-2, further comprising:
   selecting an authentication method for the UE at least based on the indication of the requesting node being the entity for AAA and the first identity of the UE; and
   generating an authentication vector for the UE at least based on the first identity of the UE.
D-5. The method (900C) of Embodiment D-3 or D-4, further comprising:
   transmitting, to the entity for AAA, a third response message for authentication credentials, which comprises:
   the authentication method,
   the authentication vector, and
   a first identity of the UE obtained from the second identity of the UE.
D-6. The method (900C) of Embodiment D-4, wherein
   the third request message for authentication credentials is received over a Diameter-based interface supporting the concealed identity of the UE, and
   the third response message for authentication credentials is transmitted over the Diameter-based interface.
D-7. The method (900C) of any of Embodiments D-1 to D-6, further comprising:
   registering, in an entity for network repository, a routing indicator that the entity for authentication in EPC supports.
D-7. The method (900C) of any of Embodiments D-2 to D-6, wherein
   the concealed identity of the UE comprises a Subscription Concealed Identifier ‘SUCI’ of the UE,
   the first identity of the UE comprises an International Mobile Subscriber Identification ‘IMSI’ of the UE, and
   the second identity of the UE comprises a Subscription Permanent Identifier ‘SUPI’ of the UE.
D-8. The method (900C) of any of Embodiments D-1 to D-7, wherein the entity for AAA comprises a 3GPP AAA server.
D-9. An entity for authentication in Evolved Packet Core ‘EPC’ (2400), comprising:
   at least one processor (2401), and
   at least one memory (2403), storing instructions which, when executed on the at least one processor (2401), cause the entity for authentication in EPC (2400) to perform the method according to at least one of Embodiments D-1 to D-8.
10 D-10. A computer readable storage medium having computer program instructions stored thereon, the computer program instructions, when executed by at least one processor, causing the at least one processor to perform the method according to at least one of Embodiments D-1 to D-8.

1. A method performed by a Non-3rd Generation Partnership Project ‘Non-3GPP’ access element in a Non-3GPP access network, the method comprising:
transmitting a list of networks, via each of which the Non-3GPP access element at least has support for User Equipment ‘UE’ identity privacy.

2. A method of claim 1, wherein the Non-3GPP access element, via each network in the list of networks, further has support for connectivity with an entity for Authentication, Authorization and Accounting ‘AAA’ for access authentication.

3. The method of claim 2, further comprising:
receiving, from a UE, a request message for access authentication comprising an identity of the UE; and
transmitting, to the entity for AAA, a request message for authentication comprising the identity of the UE.

4. The method of claim 3, wherein the identity of the UE comprises a concealed identity of the UE.

5. The method of claim 4, wherein
the concealed identity of the UE comprises a Subscription Concealed Identifier ‘SUCI’ of the UE.

6. The method of claim 3, wherein
the request message for authentication further comprises an access network identity of the Non-3GPP access network.

7-9. (canceled)

10. A method performed by a User Equipment ‘UE’, the method comprising:
determining whether UE identity privacy should be used for communication with a Non-3rd Generation Partnership Project ‘Non-3GPP’ access network for the UE; and
depending on a result of the determination, transmitting, to a Non-3GPP access element in the Non-3GPP access network, a request message for access authentication that comprises an identity of the UE.

11. The method of claim 10, wherein it is determined whether the UE identity privacy should be used for communication with the Non-3GPP access network for the UE based on at least one of:
configuration of the UE;
information about the Non-3GPP access element in the Non-3GPP access network; or
information about a home network of the UE.

12. The method of claim 11 further comprising:
receiving or preconfiguring the configuration of the UE, which comprises:
information indicating whether the UE has support for the UE identity privacy.

13. The method of claim 11, further comprising:
receiving, from the Non-3GPP access element, the information about the Non-3GPP access element indicating whether the Non-3GPP access element has support for the UE identity privacy,
wherein the information about the Non-3GPP access element comprises a list of networks, via each of which the Non-3GPP access element at least has the support for the UE identity privacy.

14. The method of claim 13, wherein the Non-3GPP access element, via each network in the list of networks, further has support for connectivity with an entity for Authentication, Authorization and Accounting ‘AAA’ for access authentication.

15. The method of claim 11, further comprising:
receiving, from the home network, the information about the home network indicating whether the home network has support for the UE identity privacy.

16. The method of claim 15, wherein the information about the home network indicating whether the home network has support for the UE identity privacy is carried in a UE Parameter Update ‘UPU’ procedure or a Steering of Roaming ‘SoR’ procedure.

17. The method of claim 12, wherein the support for the UE identity privacy comprises support for the UE identity privacy for Non-3GPP access authentication.

18. The method of claim 10, wherein
the request message for access authentication comprises a concealed identity of the UE, if it is determined that the UE identity privacy should be used, and
the request message for access authentication comprises a first identity of the UE should be used, if it is determined that the UE identity privacy should not be used.

19. The method of claim 18, wherein
the concealed identity of the UE comprises a Subscription Concealed Identifier ‘SUCI’ of the UE, and
the first identity of the UE comprises an International Mobile Subscriber Identification ‘IMSI’ of the UE.

20. The method of claim 10, wherein the communication with the Non-3GPP access network comprises Non-Seamless Wireless Local Access Network Offload ‘NSWO’ from the Non-3GPP access network for the UE.

21-23. (canceled)

24. A method performed by an entity for Authentication, Authorization and Accounting ‘AAA’, the method comprising:
receiving, from a Non-3rd Generation Partnership Project ‘Non-3GPP’ access element, a request message for authentication comprising an identity of a User Equipment ‘UE’ to be authenticated, wherein the identity of the UE comprises a concealed identity of the UE or a first identity of the UE;
detecting the identity of the UE from the received request message for authentication; and
transmitting, to an interworking entity, a first request message for authentication credentials, which at least comprises the detected identity of the UE.

25. The method of claim 24, wherein the first request message for authentication credentials is transmitted to the interworking entity via a routing entity.

26. The method of claim 24, wherein in a case where the identity of the UE in the received request message for authentication comprises the concealed identity of the UE,
the concealed identity of the UE is detected, and
the first request message for authentication credentials comprises the detected concealed identity of the UE, and is transmitted to the interworking entity over a Diameter-based interface supporting the concealed identity of the UE.

27. The method of claim 24, wherein in a case where the identity of the UE in the received request message for authentication comprises the first identity of the UE or the concealed identity of the UE that is protected with a Null Scheme,
the first identity of the UE is detected, and
the first request message for authentication credentials comprises the first identity of the UE, and is transmitted to the interworking entity over a Diameter-based interface supporting the first identity of the UE.

28. The method of claim 24, further comprising:
receiving, from the interworking entity, a first response message for authentication credentials, which comprises:
an authentication method selected by an entity for authentication in 5G Core ‘5GC’ associated with the UE or requested by the entity for authentication in 5GC from an entity for authentication in Evolved Packet Core ‘EPC’ associated with the UE,
an authentication vector generated by the entity for authentication in 5GC or requested by the entity for authentication in 5GC from the entity for authentication in EPC, and
a first identity of the UE obtained from the detected identity of the UE.

29. The method of claim 24, wherein
the concealed identity of the UE comprises a Subscription Concealed Identifier ‘SUCI’ of the UE, and
the first identity of the UE comprises an International Mobile Subscriber Identification ‘IMSI’ of the UE.

30. The method of claim 24, wherein
the request message for authentication further comprises an access network identity related to the Non-3GPP access element, and
the first request message for authentication credentials further comprises the access network identity related to the Non-3GPP access element.

31. A method performed by an entity for Authentication, Authorization and Accounting ‘AAA’, the method comprising:
receiving (S501B), from a Non-3rd Generation Partnership Project ‘Non-3GPP’ access element, a request message for authentication comprising a concealed identity of a User Equipment ‘UE’ to be authenticated;
detecting (S503B) the concealed identity of the UE from the received request message for authentication; and
transmitting (S505B), to an interworking entity, an identity request message comprising the detected concealed identity of the UE.

32. The method of claim 31, wherein the identity request message is transmitted to the interworking entity via a routing entity.

33. The method of claim 31, wherein
the concealed identity of the UE comprises a Subscription Concealed Identifier ‘SUCI’ of the UE.

34. The method of claim 31, further comprising:
receiving, from the interworking entity, an identity response message comprising a first identity of the UE, which is converted by the interworking entity from a second identity of the UE that is in turn de-concealed by an entity for authentication in 5GC associated with the UE from the concealed identity of the UE.

35. The method of claim 34, wherein
the identity request message is transmitted over a Diameter-based interface supporting the concealed identity of the UE, and
the identity response message is received over the Diameter-based interface.

36. The method of claim 34, further comprising:
transmitting, to an entity for authentication in Evolved Packet Core ‘EPC’ associated with the UE, a second request message for authentication credentials, which at least comprises the received first identity of the UE; and
receiving, from the entity for authentication in EPC, a second response message for authentication credentials, which comprises:
an authentication method selected by the entity for authentication in EPC, or requested by the entity for authentication in EPC from the entity for authentication in 5GC, and
an authentication vector generated by the entity for authentication in EPC or requested by the entity for authentication in EPC from the entity for authentication in 5GC.

37. The method of claim 34, wherein
the first identity of the UE comprises an International Mobile Subscriber Identification ‘IMSI’ of the UE, and
the second identity of the UE comprises a SUbscription Permanent Identifier ‘SUPI’ of the UE.

38. The method (500A, 500B) of claim 25, wherein
the entity for AAA comprises a 3GPP AAA server, and
the routing entity comprises a Subscription Locator Function ‘SLF’/Diameter Routing Agent ‘DRA’.

39-73. (canceled)

74. A method performed by an entity for authentication in 5G Core ‘5GC’, the method comprising:
receiving, from an interworking entity, a fourth request message for authentication credentials for a User Equipment ‘UE’ to be authenticated, which at least comprises an indication of a requesting node being an entity for Authentication, Authorization and Accounting ‘AAA’, and an identity of the UE; and
transmitting a fourth response message for authentication credentials to the interworking entity.

75. The method of claim 74, wherein the fourth request message for authentication credentials further comprises an access network identity related to a Non-3rd Generation Partnership Project ‘Non-3GPP’ access element to which the UE is connected.

76. The method of claim 74, wherein the received identity of the UE comprises a concealed identity of the UE, and
the method further comprises: de-concealing a second identity of the UE from the received concealed identity of the UE.

77. The method of claim 74, wherein the received identity of the UE comprises a second identity of the UE.

78. The method of claim 74, further comprising:
selecting an authentication method for the UE at least based on the indication of the requesting node being the entity for AAA and the second identity of the UE; and
generating an authentication vector for the UE at least based on the second identity of the UE.

79. The method of claim 76, further comprising:
transmitting, to the entity for authentication in EPC, a fifth request message for authentication credentials, which at least comprises: the indication of the requesting node being the entity for AAA, and the identity of the UE; and
receiving, from the entity for authentication in EPC, a fifth response message for authentication credentials, which comprises an authentication method for the UE and an authentication vector for the UE.

80. The method of claim 76, wherein
the concealed identity of the UE comprises a Subscription Concealed Identifier ‘SUCI’ of the UE, and
the second identity of the UE comprises a SUbscription Permanent Identifier ‘SUPI’ of the UE.

81. The method of claim 80, wherein the fifth request message for authentication credentials further comprises an access network identity related to a Non-3GPP access element to which the UE is connected.

82. A method performed by an entity for authentication in 5G Core ‘5GC’, the method comprising:
receiving (S801B), from an interworking entity, a request message for identity de-concealment, which comprises a concealed identity of a User Equipment ‘UE’ to be authenticated;
de-concealing (S803B) a second identity of the UE from the received concealed identity of the UE; and
transmitting (S805B), to the interworking entity, a response message for identity de-concealment, which comprises the second identity of the UE.

83. The method of claim 82, wherein
the concealed identity of the UE comprises a Subscription Concealed Identifier ‘SUCI’ of the UE, and
the second identity of the UE comprises a SUbscription Permanent Identifier ‘SUPI’ of the UE.

84-86. (canceled)

87. A method performed by an entity for authentication in Evolved Packet Core ‘EPC’, the method comprising:
receiving, from an entity for authentication in 5G Core ‘5GC’ associated with a User Equipment ‘UE’ to be authenticated, a fifth request message for authentication credentials, which at least comprises: an indication of a requesting node being an entity for Authentication, Authorization and Accounting ‘AAA’, and an identity of the UE;
obtaining authentication credentials for the UE; and
transmitting, to the entity for authentication in 5GC, a fifth response message for authentication credentials, which comprises the obtained authentication credentials for the UE.

88. The method of claim 87, wherein the authentication credentials for the UE comprises: an authentication method for the UE and an authentication vector for the UE, and
said obtaining the authentication credentials for the UE comprises:
selecting an authentication method for the UE at least based on the indication of the requesting node being the entity for AAA and the identity of the UE; and
generating an authentication vector for the UE at least based on the identity of the UE.

89. The method of claim 87, wherein
the identity of the UE comprises an International Mobile Subscriber Identification ‘IMSI’ of the UE or a SUbscription Permanent Identifier ‘SUPI’ of the UE.

90. The method of claim 87, wherein the fifth request message for authentication credentials further comprises an access network identity related to a Non-3GPP access element to which the UE is connected.

91. The method of claim 87, further comprising:
registering, in an entity for network repository, a routing indicator that the entity for authentication in EPC supports.

92-94. (canceled)
